(19) United States
(12) Patent Application Publication
(10) Pub. No.: US 2026/0352737 A1
(43) Pub. Date: Nov. 5, 2026

(54) EDGE-NATIVE MANAGEMENT SYSTEM OF EDGE APPLICATIONS

(71) Applicant: Intel Corporation, Santa Clara, CA (US)

(72) Inventors: Miltiadis Filippou, München (DE); Dario Sabella, Gassino (IT)

(21) Appl. No.: 19/115,665

(22) PCT Filed: Oct. 11, 2023
(86) PCT No.: PCT/US2023/034948

§ 371 Date: Mar. 26, 2025

Related U.S. Application Data
(60) Provisional application No. 63/415,444, filed on Oct. 12, 2022.

(51) Int. Cl. H04L 67/14; H04L 67/61

(52) U.S. Cl. CPC H04L 67/14; H04L 67/61

(57) ABSTRACT

Various approaches of an edge-native management system, including a session management function application for configuration of edge applications and network traffic functions, are disclosed. An example method for configuration of an edge computing application, performed by a session management function application, includes: receiving network information from an edge computing platform (e.g., MEC platform) that includes an edge computing application (e.g., MEC App), with the network information being received via a network experience function (NEF) of a mobile network (e.g., 3GPP 5G network); transmitting a request to the edge computing platform, based on the received network information, the request including an application data traffic configuration action to perform on the edge computing application; and receiving a response to the request from the edge computing platform, with the response indicating a status of the application data traffic configuration action performed on the edge computing application.

### PRIORITY CLAIM

This application claims the benefit of priority to U.S. Provisional Patent Application No. 63/415,444, filed Oct. 12, 2022, and titled “MEC-ENABLED EDGE-NATIVE MANAGEMENT SYSTEM OF EDGE APPLICATIONS”, which is incorporated herein by reference in its entirety.

### BACKGROUND

Mobile communications and edge computing have evolved significantly from early voice systems to today's highly sophisticated integrated communication platform. With the increase in different types of devices communicating with various network devices, the usage of 3GPP LTE systems has increased. The adoption of mobile devices (user equipment or UEs) in modern society has continued to drive demand for a wide variety of networked devices in many disparate environments. Fifth-generation (5G) wireless systems are expected to enable even greater speed, connectivity, and usability. Next-generation 5G networks (or NR “New Radio” networks) are expected to increase throughput, coverage, and robustness and reduce latency and operational and capital expenditures. 5G-NR networks will continue to evolve based on 3GPP LTE-Advanced with additional potential new radio access technologies (RATs) to enrich people's lives with seamless wireless connectivity solutions delivering fast, rich content and services. As the current cellular network frequency is saturated, higher frequencies, such as millimeter wave (mmWave) frequencies, can be beneficial due to their high bandwidth.

Edge computing use cases in mobile network settings have been developed for integration with multi-access edge computing (MEC) approaches, also known as “mobile edge computing.” MEC approaches are designed to allow application developers and content providers to access computing capabilities and an information technology (IT) service environment in dynamic mobile network settings at the edge of the network. Limited standards have been developed by the European Telecommunications Standards Institute (ETSI) industry specification group (ISG) in an attempt to define common interfaces for the operation of MEC systems, platforms, hosts, services, and applications.

Edge computing, MEC, and related technologies attempt to provide reduced latency, increased responsiveness, and more available computing power than offered in traditional cloud network services and wide area network connections. However, the integration of mobility and dynamically launched services to some mobile use and device processing use cases has led to limitations and concerns with orchestration, functional coordination, and resource management, especially in complex mobility settings where many participants (devices, hosts, tenants, service providers, operators) are involved. These use cases have also introduced corresponding technical challenges relating to security, processing, and network resources, service availability, and efficiency, among many other issues.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates an overview of an edge cloud configuration for edge computing using edge application management functions associated with an Edge-Native Management System (ENMS);

FIG. 2 illustrates operational layers among endpoints, an edge cloud, and cloud computing environments;

FIG. 3 illustrates an example approach for networking and services in an edge computing system using the ENMS;

FIG. 4 illustrates the deployment of a virtual edge configuration in an edge computing system operated among multiple edge nodes and multiple tenants;

FIG. 5 illustrates various compute arrangements deploying containers in an edge computing system;

FIG. 6 illustrates a compute and communication use case involving mobile access to applications in an edge computing system using the ENMS;

FIG. 7 illustrates an example mobile edge system reference architecture, arranged according to ETSI Multi-Access Edge Computing (MEC) specifications;

FIG. 8 illustrates a MEC service architecture, according to some examples;

FIG. 9A provides an overview of example components for compute deployed at a compute node in an edge computing system;

FIG. 9B provides a further overview of example components within a computing device in an edge computing system;

FIG. 9C illustrates a software distribution platform, according to some examples;

FIG. 10 illustrates an overview of 5G networking having different types of applications and quality of service requirements, according to some examples;

FIG. 11 illustrates an architecture providing a MEC federation variant of a reference MEC architecture and an 3GPP EDGEAPP architecture, according to some examples;

FIG. 12 illustrates an architecture using ETSI ISG MEC and 3GPP (SA6 EDGEAPP) interfaces, according to some examples;

FIG. 13 illustrates communication between a public land mobile network (PLMN) provider, an edge computing service provider, and an application service provider, according to some examples;

FIGS. 14A, 14B, and 14C illustrate MEC deployment options, according to some examples;

FIG. 15 illustrates a system deploying an Edge-Native Session Management Function (SMF) Engine (also referred to herein as an “ENSE application”) application, according to some examples;

FIG. 16 illustrates an example of communication between the Edge-Native SMF Engine (ENSE) application and a MEC platform, according to some examples;

FIG. 17 illustrates example communications for retrieving information about the list of traffic rules for a MEC application instance, according to some examples;

FIG. 18 illustrates example communications for retrieving information about a specific rule for a MEC application instance, according to some examples;

FIG. 19 illustrates example communications for adding a traffic rule for a MEC application instance, according to some examples;

FIG. 20 illustrates example communications for updating an existing traffic rule for a MEC application instance, according to some examples;

FIG. 21 illustrates example communications for deleting an existing traffic rule for a MEC application instance, according to some examples;

FIG. 22 illustrates an example signaling flow involving an Edge-Native SMF Engine application, a 3GPP management system, and an edge computing service provider, according to some examples;

FIG. 23 illustrates an Edge-Native Session Management Application Programming Interface (API) tree, according to some examples; and

FIG. 24 illustrates a flowchart of an example method for managing a MEC application with use of Edge-Native Session Management functions, according to some examples.

### DETAILED DESCRIPTION

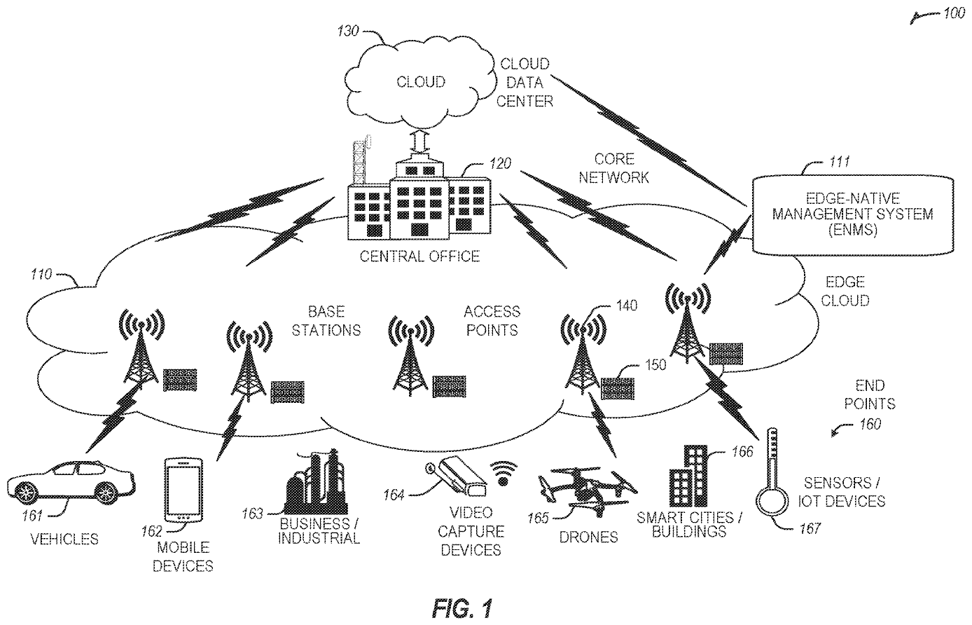

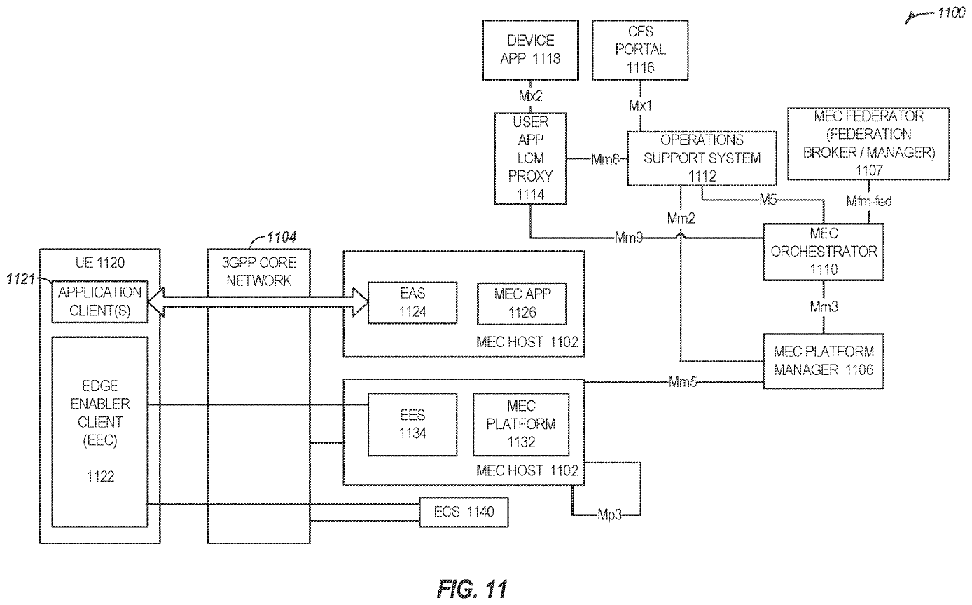

The following embodiments generally relate to a MEC-enabled edge-native management system (ENMS). Example embodiments can be implemented in systems similar to those shown in any of the systems described below in reference to FIGS. 1-10. An additional description of the ENMS and various network entities using, configuring, or performing application management is provided herein below in connection with at least FIG. 11-FIG. 24. This discussion is provided after an overview of Edge Computing and MEC networking architectures.

### Overview of Edge Computing

FIG. 1 is a block diagram 100 showing an overview of an edge cloud configuration for edge computing, capable of using application management functions associated with an edge-native management system (ENMS). Edge computing includes a layer of processing referred to in many of the following examples as an “edge cloud”. As shown, the edge cloud 110 is co-located at an edge location, such as an access point or base station 140, a local processing hub 150, or a central office 120, and thus may include multiple entities, devices, and equipment instances. The edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the edge cloud 110 provide ultra-low latency response times for services and functions used by the endpoint data sources 160 and reduce network backhaul traffic from the edge cloud 110 toward cloud data center 130, thus improving energy consumption and overall network usages among other benefits.

Compute, memory, and storage are scarce resources, and generally decrease depending on the edge location (e.g., fewer processing resources are available at consumer endpoint devices, than at a base station, than at a central office). However, the closer the edge location is to the endpoint (e.g., user equipment (UE)), the more that space and power are often constrained. Thus, edge computing attempts to reduce the number of resources needed for network services, through the distribution of more resources that are located closer to both geographically and in-network access time. In this manner, edge computing attempts to bring the compute resources to the workload data where appropriate or bring the workload data to the compute resources.

The following describes aspects of an edge cloud architecture that covers multiple potential deployments and addresses restrictions that some network operators or service providers may have in their infrastructures. These include a variety of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use cases (e.g., autonomous driving or video surveillance) for connected client devices. As an example, base stations may be augmented with compute and acceleration resources to directly process service workloads for the connected user equipment, without further communicating data via backhaul networks. As another example, central office network management hardware may be replaced with standardized compute hardware that performs virtualized network functions and offers compute resources for the execution of services and consumer functions for connected devices. Within edge computing networks, there may be scenarios in services in which the compute resource will be “moved” to the data, as well as scenarios in which the data will be “moved” to the compute resource. As an example, base station compute, acceleration and network resources can provide services to scale to workload demands on an as-needed basis by activating dormant capacity (subscription, capacity-on-demand) to manage corner cases, and emergencies or to provide longevity for deployed resources over a significantly longer implemented lifecycle.

In some examples, the edge cloud 110 and the cloud data center 130 can be configured with an ENMS 111, located in, adjacent to, or separate from the edge cloud 110. Example configurations and functionalities associated with the ENMS 111 are discussed in connection with FIGS. 11-24.

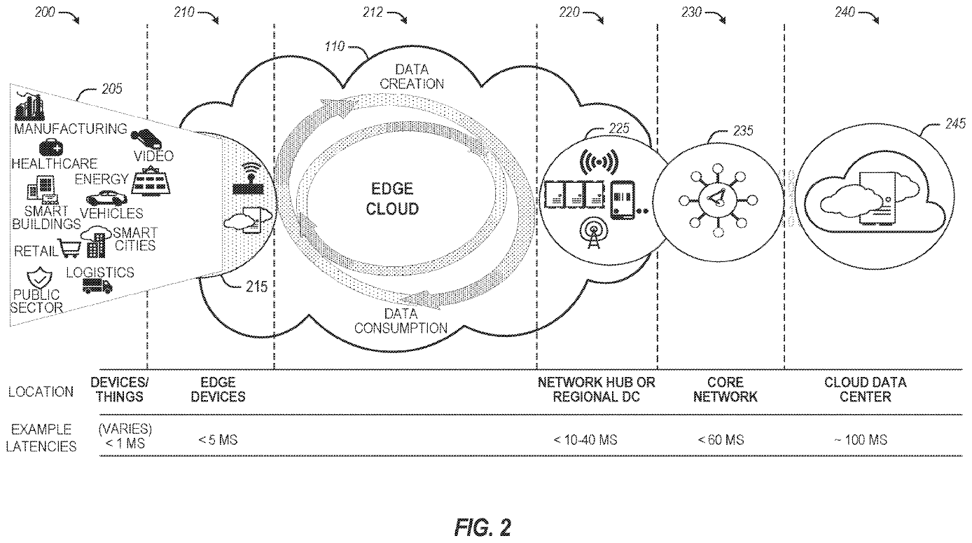

FIG. 2 illustrates operational layers among endpoints, an edge cloud, and cloud computing environments. Specifically, FIG. 2 depicts examples of computational use case 205, utilizing the edge cloud 110 among multiple illustrative layers of network computing. The layers begin at an endpoint (devices and things) layer 200, which accesses the edge cloud 110 to conduct data creation, analysis, and data consumption activities. The edge cloud 110 may span multiple network layers, such as an edge devices layer 210 having gateways, on-premise servers, or network equipment (nodes 215) located in physically proximate edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the edge cloud 110 and among the various layers may occur via any number of wired or wireless mediums, including via connectivity architectures and technologies not depicted. Any of the communication use cases 205 can be configured with functionalities associated with the ENMS 111, which may be (1) performed by a communication node configured as an orchestration management entity within a MEC network, (2) performed by a board management controller (BMC) of a computing node, or (3) performed by one or more network entities described in connection with FIGS. 11-24. Example configurations and functionalities associated with ENMS 111 are discussed in connection with FIGS. 11-24.

Examples of latency, resulting from network communication distance and processing time constraints, may range from less than a millisecond (ms) when among the endpoint layer 200, under 5 ms at the edge devices layer 210, to even between 10 to 40 ms when communicating with nodes at the network access layer 220. Beyond the edge cloud, 110 are core network layer 230 and cloud data center layer 240, with increasing latency (e.g., between 50-60 ms at the core network layer 230, to 100 or more ms at the cloud data center layer). As a result, operations at a core network data center 235 or a cloud data center 245, with latencies of at least 50 to 100 ms or more, will not be able to accomplish many time-critical functions of the use cases 205. These latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 235 or a cloud data center 245, a central office or content data network may be considered as being located within a “near edge” layer (“near” to the cloud, having high latency values when communicating with the devices and endpoints of the use cases 205), whereas an access point, base station, on-premise server, or network gateway may be considered as located within a “far edge” layer (“far” from the cloud, having low latency values when communicating with the devices and endpoints of the use cases 205). It will be understood that other categorizations of a particular network layer as constituting a “close”, “local”, “near”, “middle”, or “far” edge may be based on latency, distance, several network hops, or other measurable characteristics, as measured from a source in any of the network layers 200-240.

The various use cases 205 may access resources under usage pressure from incoming streams, due to multiple services utilizing the edge cloud. To achieve results with low latency, the services executed within the edge cloud 110 balance varying objectives (and, in some cases, requirements) in terms of (a) Priority (throughput or latency; also referred to as service level objective or SLO) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, whereas some other input streams may tolerate an occasional failure, depending on the application); and (c) Physical constraints (e.g., power, cooling, and form-factor).

The end-to-end service view for these use cases involves the concept of a service flow and is associated with a transaction. The transaction details the overall service requirement for the entity consuming the service, as well as the associated services for the resources, workloads, workflows, business functions, and business-level requirements. The services executed with the “terms” described may be managed at a respective layer in a way to assure real-time, and runtime contractual compliance for the transaction during the lifecycle of the service. When a component in the transaction is missing its agreed Service Level Agreements (SLA), the system as a whole (components in the transaction) may provide the ability to (1) understand the impact of the SLA violation, and (2) augment other components in the system to resume overall transaction SLA, and (3) implement operations to remediate.

Thus, with these variations and service features in mind, edge computing within the edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing come the following caveats. The devices located at the edge are often resource-constrained and therefore there is pressure on the usage of edge resources. Typically, this is addressed through the pooling of memory and storage resources for use by multiple users (tenants) and devices. The edge may be power and cooling-constrained and therefore the power usage needs to be accounted for by the applications that are consuming the most power. There may be inherent power-performance tradeoffs in these pooled memory resources, as many of them are likely to use emerging memory technologies, where more power invokes greater memory bandwidth. Likewise, improved security of hardware and root of trust trusted functions are also involved because edge locations may be unmanned and may even need permission access (e.g., when housed in a third-party location). Such issues are magnified in the edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 110 (network layers 200-240), which provide coordination from the client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, the cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or another thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 110.

As such, the edge cloud 110 is formed from network components and functional features operated by and within edge gateway nodes, edge aggregation nodes, or other edge compute nodes among network layers 210-230. The edge cloud 110 thus may be embodied as any type of network that provides edge computing and/or storage resources that are proximately located to radio access network (RAN) capable endpoint devices (e.g., mobile computing devices, IoT devices, smart devices, etc.), which are discussed herein. In other words, the edge cloud 110 may be envisioned as an “edge” that connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

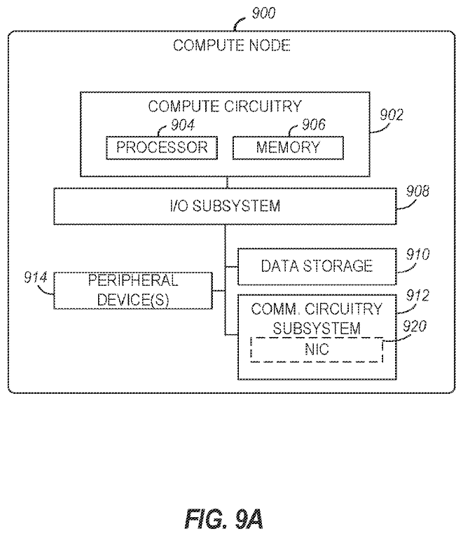

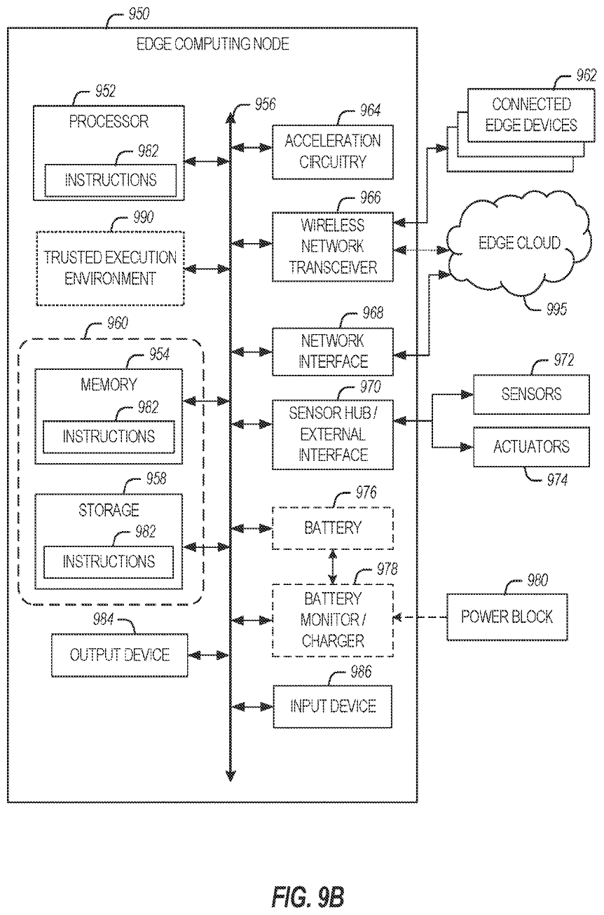

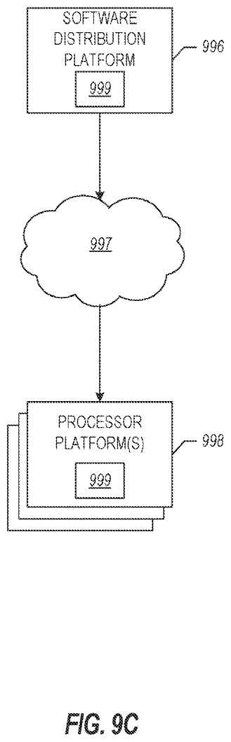

The network components of the edge cloud 110 may be servers, multi-tenant servers, appliance computing devices, and/or any other type of computing device. For example, the edge cloud 110 may include an appliance computing device that is a self-contained electronic device including a housing, a chassis, a case, or a shell. In some circumstances, the housing may be dimensioned for portability such that it can be carried by a human and/or shipped. Example housings may include materials that form one or more exterior surfaces that partially or fully protect the contents of the appliance, which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.), and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input device such as user interface hardware (e.g., buttons, switches, dials, sliders, etc.). In some circumstances, example housings include output devices contained in, carried by, embedded therein, and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent of other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIGS. 9A-9C. The edge cloud 110 may also include one or more servers and/or one or more multi-tenant servers. Such a server may include an operating system and a virtual computing environment. A virtual computing environment may include a hypervisor managing (spawning, deploying, destroying, etc.) one or more virtual machines, one or more containers, etc. Such virtual computing environments provide an execution environment in which one or more applications and/or other software, code, or scripts may execute while being isolated from one or more other applications, software, code, or scripts.

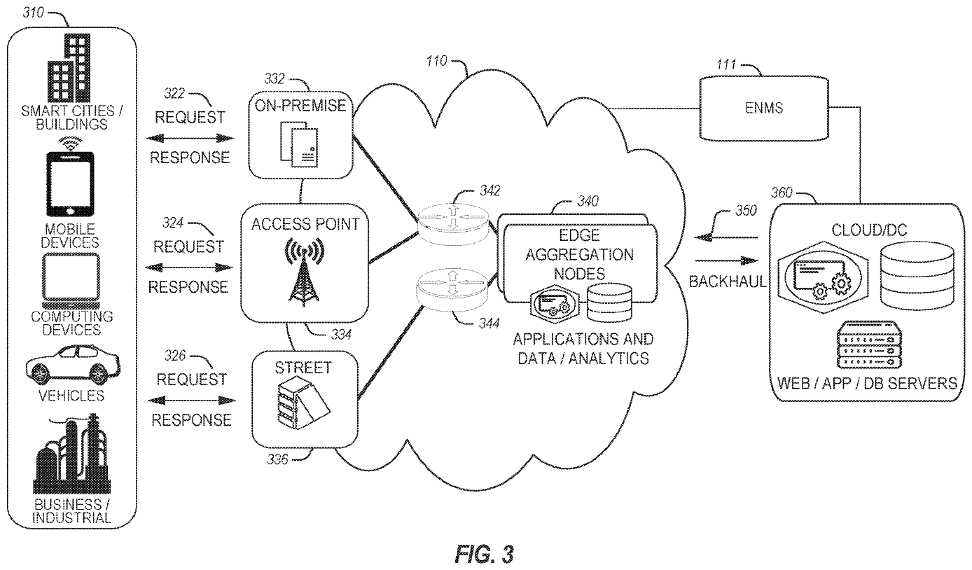

In FIG. 3, various client endpoints 310 (in the form of mobile devices, computers, autonomous vehicles, business computing equipment, and industrial processing equipment) exchange requests and responses that are specific to the type of endpoint network aggregation. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, and 344 within the edge cloud 110 to aggregate traffic and requests. Thus, within the edge cloud 110, the TSP may deploy various compute and storage resources, such as at edge aggregation nodes 340, to provide requested content. The edge aggregation nodes 340 and other systems of the edge cloud 110 are connected to a cloud or data center 360, which uses a backhaul network 350 to fulfill higher-latency requests from a cloud/data center for websites, applications, database servers, etc. Additional or consolidated instances of the edge aggregation nodes 340 and the aggregation points 342, and 344, including those deployed on a single server framework, may also be present within the edge cloud 110 or other areas of the TSP infrastructure.

In an example, the edge cloud 110 and the cloud or data center 360 utilize ENMS 111 in connection with disclosed techniques. Example configurations and functionalities associated with the ENMS 111 and associated applications are discussed in connection with FIGS. 11-24.

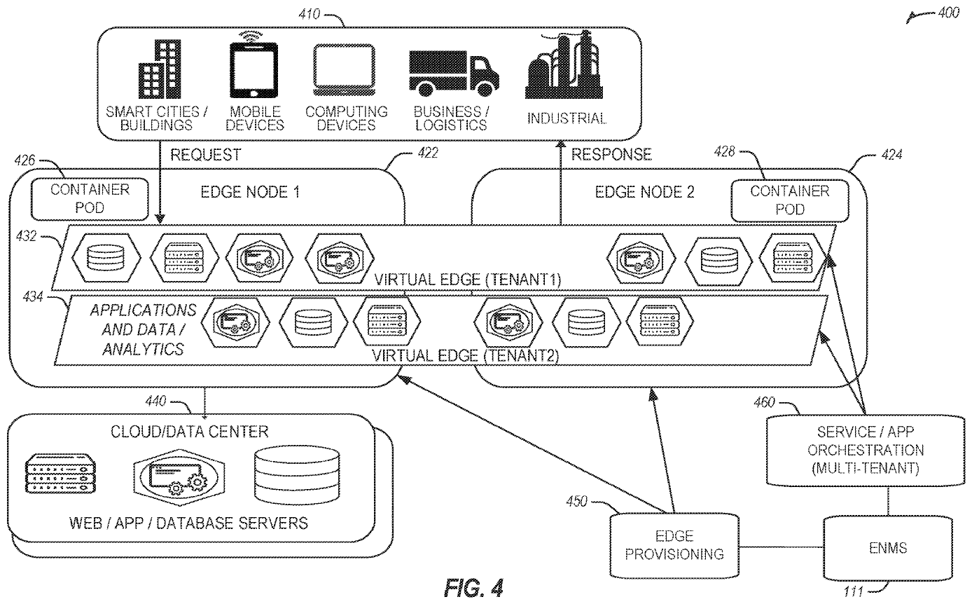

FIG. 4 illustrates deployment and orchestration for virtual edge configurations across an edge computing system operated among multiple edge nodes and multiple tenants. Specifically, FIG. 4 depicts the coordination of a first edge node 422 and a second edge node 424 in an edge computing system 400, to fulfill requests and responses for various client endpoints 410 (e.g., smart cities/building systems, mobile devices, computing devices, business/logistics systems, industrial systems, etc.), which access various virtual edge instances. Here, the virtual edge instances 432, and 434 (or virtual edges) provide edge compute capabilities and processing in an edge cloud, with access to a cloud/data center 440 for higher-latency requests for websites, applications, database servers, etc. However, the edge cloud enables the coordination of processing among multiple edge nodes for multiple tenants or entities.

In the example of FIG. 4, these virtual edge instances include: a first virtual edge instance 432, offered to a first tenant (Tenant 1), which offers the first combination of edge storage, computing, and services; and a second virtual edge instance 434, offering a second combination of edge storage, computing, and services. The virtual edge instances 432, and 434 are distributed among the edge nodes 422, and 424, and may include scenarios in which a request and response are fulfilled from the same or different edge nodes. The configuration of the edge nodes 422, and 424 to operate in a distributed yet coordinated fashion occurs based on edge provisioning functions 450. The functionality of the edge nodes 422, and 424 to provide coordinated operation for applications and services, among multiple tenants, occurs based on orchestration functions 460.

In an example, the edge provisioning functions 450 and the orchestration functions 460 can utilize the ENMS 111 in connection with disclosed techniques. Example configurations and functionalities associated with the ENMS 111 and associated applications are discussed in connection with FIGS. 11-24.

It should be understood that some of the devices in the various client endpoints 410 are multi-tenant devices where Tenant 1 may function within a tenant1 ‘slice’ while Tenant 2 may function within a tenant2 slice (and, in further examples, additional or sub-tenants may exist; and a respective tenant may even be specifically entitled and transactionally tied to a specific set of features all the way day to specific hardware features). A trusted multi-tenant device may further contain a tenant-specific cryptographic key such that the combination of key and slice may be considered a “root of trust” (RoT) or tenant-specific RoT. A RoT may further be computed dynamically composed using a DICE (Device Identity Composition Engine) architecture such that a single DICE hardware building block may be used to construct layered trusted computing base contexts for layering of device capabilities (such as a Field Programmable Gate Array (FPGA)). The RoT may further be used for a trusted computing context to enable a “fan-out” that is useful for supporting multi-tenancy. Within a multi-tenant environment, the respective edge nodes 422, and 424 may operate as security feature enforcement points for local resources allocated to multiple tenants per node. Additionally, tenant runtime and application execution (e.g., in virtual edge instances 432, 434) may serve as an enforcement point for a security feature that creates a virtual edge abstraction of resources spanning potentially multiple physical hosting platforms. Finally, the orchestration functions 460 at an orchestration entity may operate as a security feature enforcement point for marshaling resources along tenant boundaries.

Edge computing nodes may partition resources (memory, central processing unit (CPU), graphics processing unit (GPU), interrupt controller, input/output (I/O) controller, memory controller, bus controller, etc.) where respective partitionings may contain a RoT capability and where fan-out and layering according to a DICE model may further be applied to Edge Nodes. Cloud computing nodes consisting of containers, FaaS engines, Servlets, servers, or other computation abstractions may be partitioned according to a DICE layering and fan-out structure to support a RoT context. Accordingly, the respective RoTs spanning devices in 410, 422, and 440 may coordinate the establishment of a distributed trusted computing base (DTCB) such that a tenant-specific virtual trusted secure channel linking elements end to end can be established.

Further, it will be understood that a container may have data or workload-specific keys protecting its content from a previous edge node. As part of the migration of a container, a pod controller at a source edge node may obtain a migration key from a target edge node pod controller where the migration key is used to wrap the container-specific keys. When the container/pod is migrated to the target edge node, the unwrapping key is exposed to the pod controller which then decrypts the wrapped keys. The keys may now be used to perform operations on container-specific data. The migration functions may be gated by properly attested edge nodes and pod managers (as described above).

In further examples, an edge computing system is extended to provide for the orchestration of multiple applications through the use of containers (a contained, deployable unit of software that provides code and needed dependencies) in a multi-owner, multi-tenant environment. A multi-tenant orchestrator may be used to perform key management, trust anchor management and other security functions related to the provisioning and lifecycle of the trusted ‘slice’ concept in FIG. 4. For instance, an edge computing system may be configured to fulfill requests and responses for various client endpoints from multiple virtual edge instances (and, from a cloud or remote data center). The use of these virtual edge instances may support multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications; latency-sensitive applications; latency-critical applications; user plane applications; networking applications; etc.). The virtual edge instances may also be spanned across systems of multiple owners at different geographic locations (or respective computing systems and resources which are co-owned or co-managed by multiple owners).

For instance, a respective edge node 422, 424 may implement the use of containers, such as with the use of a container “pod” 426, 428 providing a group of one or more containers. In a setting that uses one or more container pods, a pod controller or orchestrator is responsible for local control and orchestration of the containers in the pod. Various edge node resources (e.g., storage, compute, services, depicted with hexagons) provided for the respective edge slices of virtual edge instances 432, 434 are partitioned according to the needs of a respective container.

With the use of container pods, a pod controller oversees the partitioning and allocation of containers and resources. The pod controller receives instructions from an orchestrator (e.g., performing orchestration functions 460) that instructs the controller on how best to partition physical resources and for what duration, such as by receiving key performance indicator (KPI) targets based on SLA contracts. The pod controller determines which container uses which resources and for how long to complete the workload and satisfy the SLA. The pod controller also manages container lifecycle operations such as: creating the container, provisioning it with resources and applications, coordinating intermediate results between multiple containers working on a distributed application together, dismantling containers when the workload completes, and the like. Additionally, a pod controller may serve a security role that prevents the assignment of resources until the right tenant authenticates or prevents the provisioning of data or a workload to a container until an attestation result is satisfied.

Also, with the use of container pods, tenant boundaries can still exist but in the context of respective pods of containers. If a respective tenant-specific pod has a tenant-specific pod controller, there will be a shared pod controller that consolidates resource allocation requests to avoid typical resource starvation situations. Further controls may be provided to ensure the attestation and trustworthiness of the pod and pod controller. For instance, the orchestration functions 460 may provision an attestation verification policy to local pod controllers that perform attestation verification. If an attestation satisfies a policy for a first tenant pod controller but not a second tenant pod controller, then the second pod could be migrated to a different edge node that does satisfy it. Alternatively, the first pod may be allowed to execute and a different shared pod controller is installed and invoked before the second pod executes.

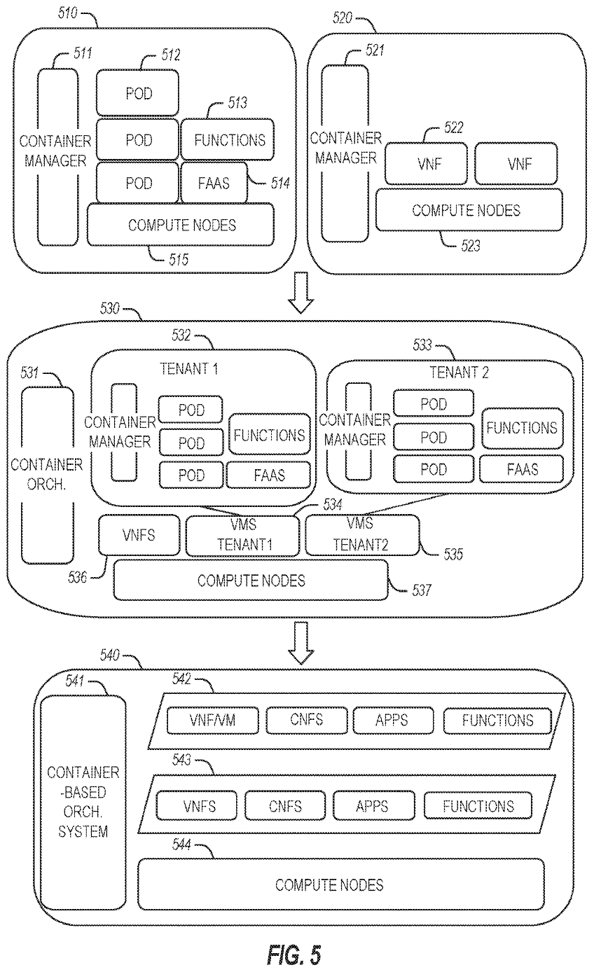

FIG. 5 illustrates additional compute arrangements deploying containers in an edge computing system. As a simplified example, system arrangements 510, and 520 depict settings in which a pod controller (e.g., container managers 511, 521, and container orchestrator 531) is adapted to launch containerized pods, functions, and functions-as-a-service instances through execution via compute nodes (e.g., compute nodes 515 in arrangement 510) or to separately execute containerized virtualized network functions through execution via compute nodes (e.g., compute nodes 523 in arrangement 520). This arrangement is adapted for use of multiple tenants in system arrangement 530 (using compute nodes 537), where containerized pods (e.g., pods 512), functions (e.g., functions 513, VNFs 522, 536), and functions-as-a-service instances (e.g., FaaS instance 514) are launched within virtual machines (e.g., VMs 534, 535 for tenants 532, 533) specific to respective tenants (aside from the execution of virtualized network functions). This arrangement is further adapted for use in system arrangement 540, which provides containers 542, and 543, or execution of the various functions, applications, and functions on compute nodes 544, as coordinated by a container-based orchestration system 541.

The system arrangements depicted in FIG. 5 provide an architecture that treats VMs, Containers, and Functions equally in terms of application composition (and resulting applications are combinations of these three ingredients). A respective ingredient may involve the use of one or more accelerator (FPGA, ASIC) components as a local backend. In this manner, applications can be split across multiple edge owners, coordinated by an orchestrator.

In the context of FIG. 5, the pod controller/container manager, container orchestrator, and individual nodes may provide a security enforcement point. However, tenant isolation may be orchestrated where the resources allocated to a tenant are distinct from resources allocated to a second tenant, but edge owners cooperate to ensure resource allocations are not shared across tenant boundaries. Or, resource allocations could be isolated across tenant boundaries, as tenants could allow “use” via a subscription or transaction/contract basis. In these contexts, virtualization, containerization, enclaves, and hardware partitioning schemes may be used by edge owners to enforce tenancy. Other isolation environments may include bare metal (dedicated) equipment, virtual machines, containers, virtual machines on containers, or combinations thereof.

In further examples, aspects of software-defined or controlled silicon hardware, and other configurable hardware, may integrate with the applications, functions, and services of an edge computing system. Software-defined silicon may be used to ensure the ability of some resource or hardware ingredient to fulfill a contract or service level agreement, based on the ingredient's ability to remediate a portion of itself or the workload (e.g., by an upgrade, reconfiguration, or provision of new features within the hardware configuration itself).

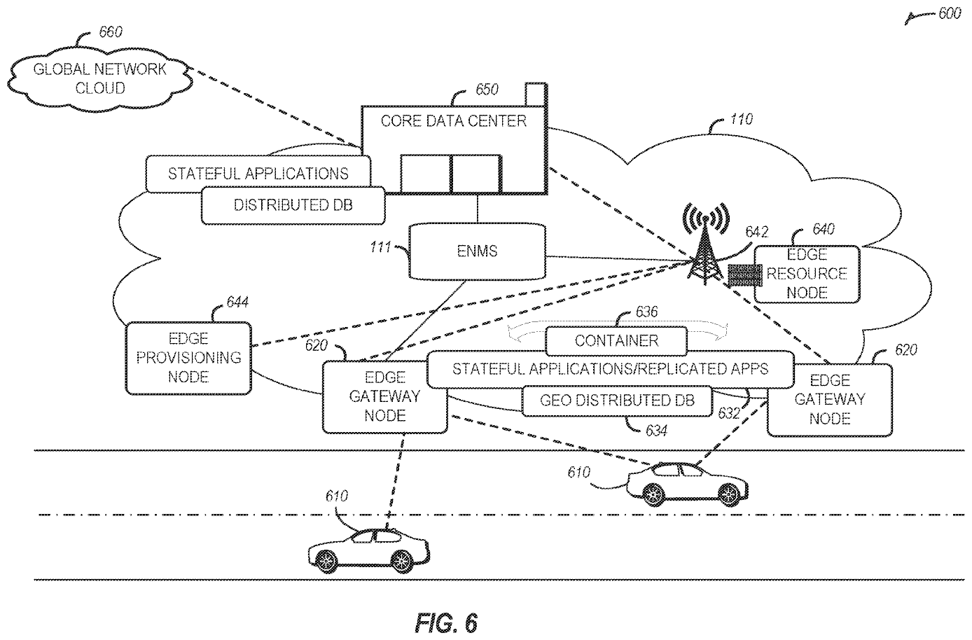

It should be appreciated that the edge computing systems and arrangements discussed herein may be applicable in various solutions, services, and/or use cases involving mobility. As an example, FIG. 6 shows a simplified vehicle compute and communication use case involving mobile access to applications in an edge computing system 600 that implements an edge cloud 110. In this use case, the respective client computes nodes (or devices) 610 may be embodied as in-vehicle compute systems (e.g., in-vehicle navigation and/or infotainment systems) located in corresponding vehicles that communicate with the edge gateway nodes (or devices) 620 during traversal of a roadway. For instance, the edge gateway nodes 620 may be located in a roadside cabinet or other enclosure built into a structure having other, separate, mechanical utility, which may be placed along the roadway, at intersections of the roadway, or in other locations near the roadway. As respective vehicles traverse along the roadway, the connection between its client compute node 610 and a particular edge gateway node 620 may propagate to maintain a consistent connection and context for the client compute node 610. Likewise, mobile edge nodes may aggregate at the high-priority services or according to the throughput or latency resolution 5 requirements for the underlying service(s) (e.g., in the case of drones). The respective edge gateway nodes 620 include an amount of processing and storage capabilities and, as such, some processing and/or storage of data for the client compute nodes 610 may be performed on one or more of the edge gateway nodes 620.

The edge gateway nodes 620 may communicate with one or more edge resource nodes 640, which are illustratively embodied as compute servers, appliances, or components 30 located at or in a communication base station 642 (e.g., a base station of a cellular network). As discussed above, the respective edge resource nodes 640 include an amount of processing and storage capabilities, and, as such, some processing and/or storage of data for the client compute nodes 610 may be performed on the edge resource node 640. For example, the processing of data that is less urgent or important may be performed by the edge resource node 640, while the processing of data that is of a higher urgency or importance may be performed by the edge gateway nodes 620 (depending on, for example, the capabilities of a component, or information in the request indicating urgency or importance). Based on data access, data location, or latency, work may continue on edge resource nodes when the processing priorities change during the processing activity. Likewise, configurable systems or hardware resources themselves can be activated (e.g., through a local orchestrator) to provide additional resources to meet the new demand (e.g., adapt the compute resources to the workload data).

The edge resource node(s) 640 also communicates with the core data center 650, which may include compute servers, appliances, and/or other components located in a central location (e.g., a central office of a cellular communication network). The core data center 650 may provide a gateway to the global network cloud 660 (e.g., the Internet) for the edge cloud 110 operations formed by the edge resource node(s) 640 and the edge gateway nodes 620. Additionally, in some examples, the core data center 650 may include an amount of processing and storage capabilities and, as such, some processing and/or storage of data for the client compute devices may be performed on the core data center 650 (e.g., processing of low urgency or importance, or high complexity).

The edge gateway nodes 620 or the edge resource nodes 640 may offer the use of stateful applications 632 and a geographically distributed database 634. Although applications 632 and database 634 are illustrated as being horizontally distributed at a layer of the edge cloud 110, it will be understood that resources, services, or other components of the application may be vertically distributed throughout the edge cloud (including, part of the application executed at the client compute node 610, other parts at the edge gateway nodes 620 or the edge resource nodes 640, etc.). Additionally, as stated previously, there can be peer relationships at any level to meet service objectives and obligations. Further, the data for a specific client or application can move from edge to edge based on changing conditions (e.g., based on acceleration resource availability, following the car movement, etc.). For instance, based on the “rate of decay” of access, a prediction can be made to identify the next owner to continue, or when the data or computational access will no longer be viable. These and other services may be utilized to complete the work that is needed to keep the transaction compliant and lossless.

In further scenarios, a container 636 (or a pod of containers) may be flexibly migrated from an edge gateway node 620 to other edge nodes (e.g., 620, 640, etc.) such that the container with an application and workload does not need to be reconstituted, re-compiled, re-interpreted for migration to work. However, in such settings, there may be some remedial or “swizzling” translation operations applied. For example, the physical hardware at node 640 may differ from edge gateway node 620 and therefore, the hardware abstraction layer (HAL) that makes up the bottom edge of the container will be re-mapped to the physical layer of the target edge node. This may involve some form of late-binding technique, such as binary translation of the HAL from the container-native format to the physical hardware format, or may involve mapping interfaces and operations. A pod controller may be used to drive the interface mapping as part of the container lifecycle, which includes migration to/from different hardware environments.

The scenarios encompassed by FIG. 6 may utilize various types of mobile edge nodes, such as an edge node hosted in a vehicle (car/truck/tram/train) or other mobile units, as the edge node will move to other geographic locations along the platform hosting it. With vehicle-to-vehicle communications, individual vehicles may even act as network edge nodes for other cars, (e.g., to perform caching, reporting, data aggregation, etc.). Thus, it will be understood that the application components provided in various edge nodes may be distributed in static or mobile settings, including coordination between some functions or operations at individual endpoint devices or the edge gateway nodes 620, some others at the edge resource node 640, and others in the core data center 650 or global network cloud 660.

In an example, the edge cloud 110 in FIG. 6 utilizes the ENMS 111 in connection with disclosed techniques. Example configurations and functionalities associated with the ENMS 111 and associated applications are discussed in connection with FIGS. 11-24.

In further configurations, the edge computing system may implement FaaS computing capabilities through the use of respective executable applications and functions. In an example, a developer writes function code (e.g., “computer code” herein) representing one or more computer functions, and the function code is uploaded to a FaaS platform provided by, for example, an edge node or data center. A trigger such as, for example, a service use case or an edge processing event, initiates the execution of the function code with the FaaS platform.

In an example of FaaS, a container is used to provide an environment in which function code (e.g., an application that may be provided by a third party) is executed. The container may be any isolated execution entity such as a process, a Docker or Kubernetes container, a virtual machine, etc. Within the edge computing system, various data center, edge, and endpoint (including mobile) devices are used to “spin up” functions (e.g., activate and/or allocate function actions) that are scaled on demand. The function code gets executed on the physical infrastructure (e.g., edge computing node) device and underlying virtualized containers. Finally, the container is “spun down” (e.g., deactivated and/or deallocated) on the infrastructure in response to the execution being completed.

Further aspects of FaaS may enable deployment of edge functions in a service fashion, including support of respective functions that support edge computing as a service (Edge-as-a-Service or “EaaS”). Additional features of FaaS may include a granular billing component that enables customers (e.g., computer code developers) to pay only when their code gets executed; common data storage to store data for reuse by one or more functions; orchestration and management among individual functions; function execution management, parallelism, and consolidation; management of container and function memory spaces;

coordination of acceleration resources available for functions; and distribution of functions between containers (including “warm” containers, already deployed or operating, versus “cold” containers that involve initialization, deployment, or configuration).

The edge computing system 600 can include or be in communication with an edge provisioning node 644. The edge provisioning node 644 can distribute software such as the example computer-readable (also referred to as machine-readable) instructions 982 of FIG. 9B, to various receiving parties for implementing any of the methods described herein. The example edge provisioning node 644 may be implemented by any computer server, home server, content delivery network, virtual server, software distribution system, central facility, storage device, storage disks, storage node, data facility, cloud service, etc., capable of storing and/or transmitting software instructions (e.g., code, scripts, executable binaries, containers, packages, compressed files, and/or derivatives thereof) to other computing devices. Component(s) of the example edge provisioning node 644 may be located in a cloud, in a local area network, in an edge network, in a wide area network, on the Internet, and/or any other location communicatively coupled with the receiving party (or parties). The receiving parties may be customers, clients, associates, users, etc. of the entity owning and/or operating the edge provisioning node 644. For example, the entity that owns and/or operates the edge provisioning node 644 may be a developer, a seller, and/or a licensor (or a customer and/or consumer thereof) of software instructions such as the example computer-readable instructions 982 (also referred to as machine-readable instructions 982) of FIG. 9B. The receiving parties may be consumers, service providers, users, retailers, OEMs, etc., who purchase and/or license the software instructions for use and/or re-sale and/or sub-licensing.

In an example, the edge provisioning node 644 includes one or more servers and one or more storage devices/disks. The storage devices and/or storage disks host computer-readable instructions such as the example computer-readable instructions 982 of FIG. 9B, as described below. Similar to edge gateway nodes 620 described above, one or more servers of the edge provisioning node 644 are in communication with a base station 642 or other network communication entity. In some examples, one or more servers are responsive to requests to transmit the software instructions to a requesting party as part of a commercial transaction. Payment for the delivery, sale, and/or license of the software instructions may be handled by one or more servers of the software distribution platform and/or via a third-party payment entity. The servers enable purchasers and/or licensors to download the computer-readable instructions 982 from the edge provisioning node 644. For example, the software instructions, which may correspond to the example computer-readable instructions 982 of FIG. 9B may be downloaded to the example processor platform/s, which is to execute the computer-readable instructions 982 to implement the methods described herein.

In some examples, the processor platform(s) that execute the computer-readable instructions 982 can be physically located in different geographic locations, legal jurisdictions, etc. In some examples, one or more servers of the edge provisioning node 644 periodically offer, transmit, and/or force updates to the software instructions (e.g., the example computer-readable instructions 982 of FIG. 9B) to ensure improvements, patches, updates, etc. are distributed and applied to the software instructions implemented at the end-user devices. In some examples, different components of the computer-readable instructions 982 can be distributed from different sources and/or to different processor platforms; for example, different libraries, plug-ins, components, and other types of compute modules, whether compiled or interpreted, can be distributed from different sources and/or to different processor platforms. For example, a portion of the software instructions (e.g., a script that is not, in itself, executable) may be distributed from a first source while an interpreter (capable of executing the script) may be distributed from a second source.

### Overview of MEC Reference Architecture

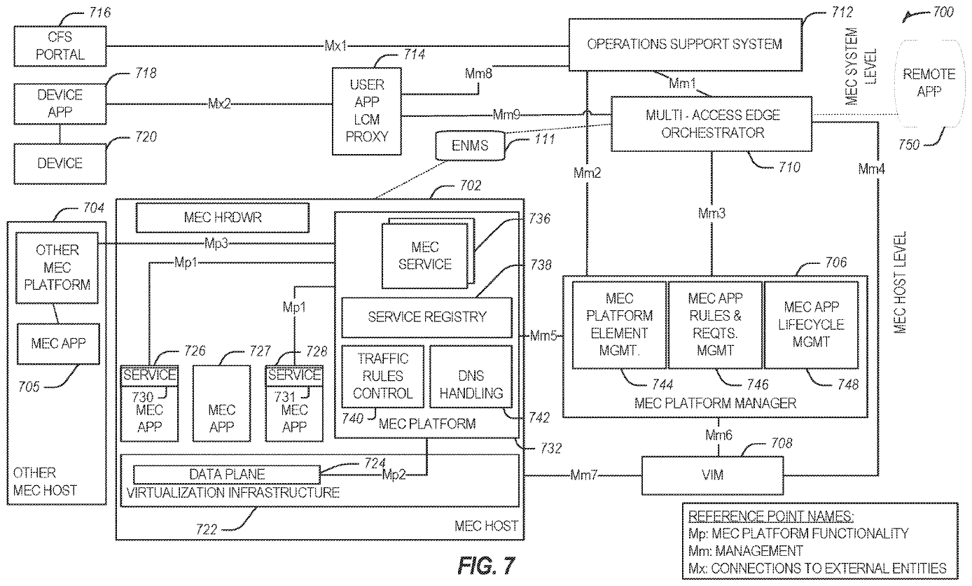

FIG. 7 illustrates a mobile edge system reference architecture (or MEC architecture) 700, such as is indicated by example ETSI MEC specifications. FIG. 7 specifically illustrates a MEC architecture 700 with MEC hosts 702 and 704 providing functionalities in accordance with the ETSI GS MEC-003 specification. In some examples, enhancements to the MEC platform 732 and the MEC platform manager 706 may be used for providing specific computing functions within the MEC architecture 700.

Referring to FIG. 7, the MEC network architecture 700 can include MEC hosts 702 and 704, a virtualization infrastructure manager (VIM) 708, a MEC platform manager 706, a MEC orchestrator 710, an operations support system 712, a user app proxy 714, a UE app 718 running on UE 720, and CFS portal 716. The MEC host 702 can include a MEC platform 732 with filtering rules control component 740, a DNS handling component 742, a service registry 738, and MEC services 736. The MEC services 736 can include at least one scheduler, which can be used to select resources for instantiating MEC apps (or network function virtualization (NFV) functions) 726, 727, and 728 upon virtualization infrastructure 722. The MEC apps 726 and 728 can be configured to provide services 730 and 731, which can include processing network communications traffic of different types associated with one or more wireless connections (e.g., connections to one or more RAN or telecom-core network entities). The MEC app 705 instantiated within MEC host 704 can be similar to the MEC apps 726-728 instantiated within MEC host 702. The virtualization infrastructure 722 includes a data plane 724 coupled to the MEC platform via an MP2 interface. Additional interfaces between various network entities of the MEC architecture 700 are illustrated in FIG. 7.

The MEC platform manager 706 can include MEC platform element management component 744, MEC app rules and requirements management component 746, and MEC app lifecycle management component 748. The various entities within the MEC architecture 700 can perform functionalities as disclosed by the ETSI GS MEC-003 specification. In some examples, the remote application (or app) 750 is configured to communicate with the MEC host 702 (e.g., with the MEC apps 726-728) via the MEC orchestrator 710 and the MEC platform manager 706.

In some examples, the MEC architecture 700 may be configured with ENMS 111, which can communicate with the MEC orchestrator 710 and the MEC host 702 (e.g., via a core network such as a 5G core network). Example configurations and functionalities associated with ENMS 111 and associated applications are discussed in connection with FIGS. 11-24.

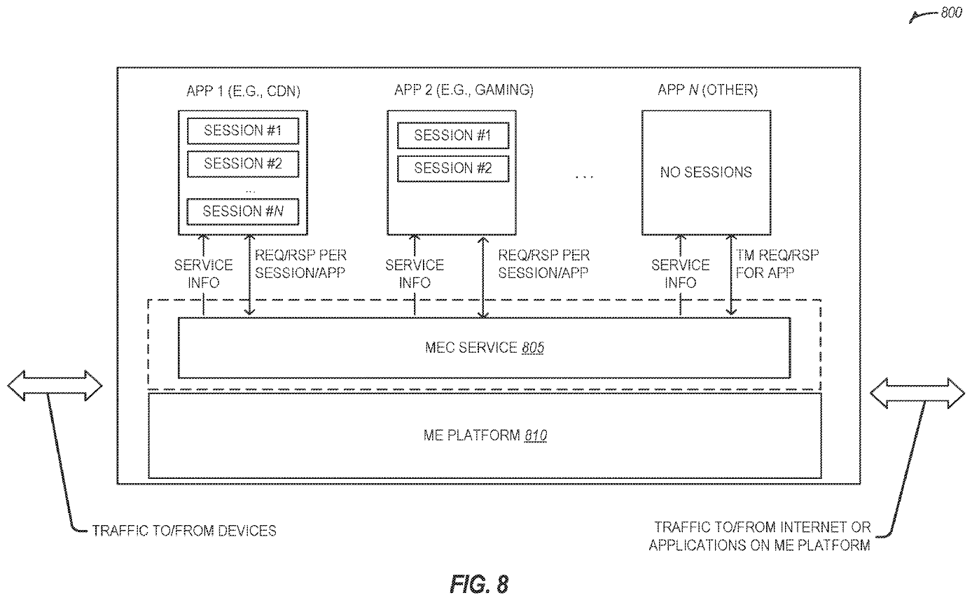

FIG. 8 illustrates a MEC service architecture 800, according to some examples. MEC service architecture 800 includes the MEC service 805, a multi-access edge (ME) platform 810 (corresponding to MEC platform 732), and applications (Apps) 1 to N (where N is a number). As an example, App 1 may be a content delivery network (CDN) app/service hosting 1, . . . , n sessions (where n is a number that is the same or different than N), App 2 may be a gaming app/service which is shown as hosting two sessions, and App N may be some other app/service which is shown as a single instance (e.g., not hosting any sessions). A respective App may be a distributed application that partitions tasks and/or workloads between resource providers (e.g., servers such as ME platform 810) and consumers (e.g., UEs, user apps instantiated by individual UEs, other servers/services, network functions, application functions, etc.). A respective session represents an interactive information exchange between two or more elements, such as a client-side app and its corresponding server-side app, a user app instantiated by a UE, and a MEC app instantiated by the ME platform 810, and/or the like. A session may begin when App execution is started or initiated and ends when the App exits or terminates execution. Additionally or alternatively, a session may begin when a connection is established and may end when the connection is terminated. A respective App session may correspond to a currently running App instance. Additionally, a respective session may correspond to a Protocol Data Unit (PDU) session or a multi-access (MA) PDU session. A PDU session is an association between a UE and a Data Network that provides a PDU connectivity service, which is a service that provides for the exchange of PDUs between a UE and a Data Network. An MA PDU session is a PDU Session that provides a PDU connectivity service, which can use one access network at a time, or simultaneously a 3GPP access network and a non-3GPP access network. Furthermore, a respective session may be associated with a session identifier (ID) which is data that uniquely identifies a session, and a respective App (or App instance) may be associated with an App ID (or App instance ID) which is data that uniquely identifies an App (or App instance).

The MEC service 805 provides one or more MEC services 736 to MEC service consumers (e.g., Apps 1 to N). The MEC service 805 may optionally run as part of the platform (e.g., ME platform 810) or as an application (e.g., ME app). Different Apps 1 to N, whether managing a single instance or several sessions (e.g., CDN), may request specific service information per defined requirements for the whole application instance or different requirements per session. The MEC service 805 may aggregate requests and act in a manner that will help optimize the BW usage and improve the Quality of Experience (QoE) for applications.

The MEC service 805 provides a MEC service API that supports both queries and subscriptions (e.g., pub/sub mechanism) that are used over a Representational State Transfer (“REST” or “RESTful”) API or alternative transports such as a message bus. For RESTful architectural style, the MEC APIs contain the HTTP protocol bindings for traffic management functionality.

A respective Hypertext Transfer Protocol (HTTP) message is either a request or a response. A server listens on a connection for a request, parses messages received, interprets the message semantics concerning the identified request target, and responds to that request with one or more response messages. A client constructs request messages to communicate specific intentions, examines received responses to see if the intentions were carried out, and determines how to interpret the results. The target of an HTTP request is called a “resource”. Additionally, a “resource” is an object with a type, associated data, a set of methods that operate on it, and relationships to other resources if applicable. A respective resource is identified by at least one Uniform Resource Identifier (URI), and a resource URI identifies at most one resource. Resources are acted upon by the RESTful API using HTTP methods (e.g., POST, GET, PUT, DELETE, etc.). With every HTTP method, one resource URI is passed in the request to address one particular resource. Operations on resources affect the state of the corresponding managed entities.

Considering that a resource could be anything and that the uniform interface provided by HTTP is similar to a window through which one can observe and act upon such a thing only through the communication of messages to some independent actor on the other side, an abstraction is needed to represent (“take the place of”) the current or desired state of that thing in our communications. That abstraction is called a representation. For HTTP, a “representation” is information that is intended to reflect a past, current, or desired state of a given resource, in a format that can be readily communicated via the protocol. A representation comprises a set of representation metadata and a potentially unbounded stream of representation data. Additionally, a resource representation is a serialization of a resource state in a particular content format.

An origin server might be provided with, or be capable of generating, multiple representations that are intended to reflect the current state of a target resource. In such cases, some algorithm is used by the origin server to select one of those representations as most applicable to a given request, usually based on content negotiation. This “selected representation” is used to provide the data and metadata for evaluating conditional requests and constructing the payload for response messages (e.g., 200 OK, 304 Not Modified responses to GET, and the like). A resource representation is included in the payload body of an HTTP request or response message. Whether a representation is required or not allowed in a request depends on the HTTP method used (see e.g., Fielding et al., “Hypertext Transfer Protocol (HTTP/1.1): Semantics and Content”, IETF RFC 7231 (June 2014)).

The MEC API resource Universal Resource Indicators (URIs) are discussed in various ETSI MEC standards, such as those mentioned herein. The MTS API supports additional application-related error information to be provided in the HTTP response when an error occurs (see e.g., clause 6.15 of ETSI GS MEC 009 V2.1.1 (2019-01)). The syntax of a respective resource URI follows ETSI GS MEC 009, as well as Berners-Lee et al., “Uniform Resource Identifier (URI): Generic Syntax”, IETF Network Working Group, RFC 3986 (January 2005) and/or Nottingham, “URI Design and Ownership”, IETF RFC 8820 (June 2020). In the RESTful MEC service APIs, including the VIS API, the resource URI structure for a respective API has the following structure:
{apiRoot}/{apiName}/{apiVersion}/{apiSpecificSuffixes}

Here, “apiRoot” includes the scheme (“HTTPS”), host and optional port, and an optional prefix string. The “apiName” defines the name of the API (e.g., MTS API, RNI API, etc.). The “apiVersion” represents the version of the API, and the “apiSpecificSuffixes” define the tree of resource URIs in a particular API. The combination of “apiRoot”, “apiName” and “apiVersion” is called the root URI. The “apiRoot” is under the control of the deployment, whereas the remaining parts of the URI are under the control of the API specification. In the above root, “apiRoot” and “apiName” are discovered using the service registry (see e.g., service registry 738 in FIG. 7). It includes the scheme (“http” or “https”), host, and optional port, and an optional prefix string. For a given MEC API, the “apiName” may be set to “mec” and “apiVersion” may be set to a suitable version number (e.g., “v1” for version 1). The MEC APIs support HTTP over TLS (also known as HTTPS). Resource URIs in the MEC API procedures are defined relative to the above root URI.

The JSON content format may also be supported. The JSON format is signaled by the content type “application/json”. The MTS API may use the OAuth 2.0 client credentials grant type with bearer tokens (see e.g., ETSI GS MEC 009). The token endpoint can be discovered as part of the service availability query procedure defined in ETSI GS MEC 009. The client credentials may be provisioned into the MEC app using known provisioning mechanisms.

Computing Implementation Examples In further examples, any of the compute nodes or devices discussed with reference to the present edge computing systems and environment may be fulfilled based on the components depicted in FIGS. 9A and 9B. Respective edge compute nodes may be embodied as a type of device, appliance, computer, or other “thing” capable of communicating with other edges, networking, or endpoint components. For example, an edge compute device may be embodied as a personal computer, a server, a smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 9A, an edge compute node 900 includes a compute engine (also referred to herein as “compute circuitry”) 902, an input/output (I/O) subsystem 908, one or more data storage devices 910, a communication circuitry subsystem 912, and, optionally, one or more peripheral devices 914. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 900 may be embodied as any type of engine, device, or collection of devices capable of performing various compute functions. In some examples, the compute node 900 may be embodied as a single device such as an integrated circuit, an embedded system, a field-programmable gate array (FPGA), a system-on-a-chip (SOC), or another integrated system or device. In the illustrative example, the compute node 900 includes or is embodied as a processor 904 and a memory 906. Processor 904 may be embodied as any type of processor capable of performing the functions described herein (e.g., executing an application). For example, processor 904 may be embodied as a multi-core processor(s), a microcontroller, a processing unit, a specialized or special purpose processing unit, or another processor or processing/controlling circuit.

In some examples, the processor 904 may be embodied as, include, or be coupled to an FPGA, an application-specific integrated circuit (ASIC), reconfigurable hardware or hardware circuitry, or other specialized hardware to facilitate the performance of the functions described herein. Also in some examples, the processor 904 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within a SOC or integrated with networking circuitry (e.g., in a SmartNIC, or enhanced SmartNIC), acceleration circuitry, storage devices, or AI hardware (e.g., GPUs, programmed FPGAs, Network Processing Units (NPUs), Infrastructure Processing Units (IPUs), Storage Processing Units (SPUs), AI Processors (APUs), Data Processing Unit (DPUs), or other specialized accelerators such as a cryptographic processing unit/accelerator). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general-purpose processing hardware. However, it will be understood that an xPU, a SOC, a CPU, and other variations of the processor 904 may work in coordination with each other to execute many types of operations and instructions within and on behalf of the compute node 900.

Memory 906 may be embodied as any type of volatile (e.g., dynamic random access memory (DRAM), etc.) or non-volatile memory or data storage capable of performing the functions described herein. Volatile memory may be a storage medium that uses power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In some aspects, the memory device is a block addressable memory device, such as those based on NAND or NOR technologies. A memory device may also include a three-dimensional crosspoint memory device, or other byte-addressable write-in-place nonvolatile memory devices. The memory device may refer to the die itself and/or to a packaged memory product. In some examples, 3D crosspoint memory may comprise a transistor-less stackable cross-point architecture in which memory cells sit at the intersection of word lines and bit lines and are individually addressable and in which bit storage is based on a change in bulk resistance. In some examples, all or a portion of the memory 906 may be integrated into the processor 904. The memory 906 may store various software and data used during operation such as one or more applications, data operated on by the application(s), libraries, and drivers.

In an example, the memory device (e.g., memory circuitry) is any number of block addressable memory devices, such as those based on NAND or NOR technologies (for example, Single-Level Cell (“SLC”), Multi-Level Cell (“MLC”), Quad-Level Cell (“QLC”), Tri-Level Cell (“TLC”), or some other NAND). In some examples, the memory device(s) includes a byte-addressable write-in-place three-dimensional crosspoint memory device, or other bytes addressable write-in-place non-volatile memory (NVM) devices, such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric transistor random access memory (FeTRAM), magnetoresistive random access memory (MRAM) that incorporates memristor technology, spin-transfer torque (STT)-MRAM, a spintronic magnetic junction memory-based device, a magnetic tunneling junction (MTJ) based device, a DW (Domain Wall) and SOT (Spin-Orbit Transfer) based device, a thyristor-based memory device, a combination of any of the above, or other suitable memory. A memory device may also include a three-dimensional crosspoint memory device, or other byte-addressable write-in-place nonvolatile memory devices. The memory device may refer to the die itself and/or to a packaged memory product. In some examples, 3D crosspoint memory may include a transistor-less stackable cross-point architecture in which memory cells sit at the intersection of word lines and bit lines and are individually addressable and in which bit storage is based on a change in bulk resistance. In some examples, all or a portion of the memory 906 may be integrated into the processor 904. The memory 906 may store various software and data used during operation such as one or more applications, data operated on by the application(s), libraries, and drivers.

In some examples, resistor-based and/or transistor-less memory architectures include nanometer-scale phase-change memory (PCM) devices in which a volume of phase-change material resides between at least two electrodes. Portions of the example phase-change material exhibit varying degrees of crystalline phases and amorphous phases, in which varying degrees of resistance between at least two electrodes can be measured. In some examples, the phase-change material is a chalcogenide-based glass material. Such resistive memory devices are sometimes referred to as memristive devices that remember the history of the current that previously flowed through them. Stored data is retrieved from example PCM devices by measuring the electrical resistance, in which the crystalline phases exhibit a relatively lower resistance value(s) (e.g., logical “0”) when compared to the amorphous phases having a relatively higher resistance value(s) (e.g., logical “1”).

Example PCM devices store data for long periods (e.g., approximately 10 years at room temperature). Write operations to example PCM devices (e.g., set to logical “0”, set to logical “1”, set to an intermediary resistance value) are accomplished by applying one or more current pulses to at least two electrodes, in which the pulses have a particular current magnitude and duration. For instance, a long low current pulse (SET) applied to at least two electrodes causes the example PCM device to reside in a low-resistance crystalline state, while a comparatively short high current pulse (RESET) applied to the at least two electrodes causes the example PCM device to reside in a high-resistance amorphous state.

In some examples, the implementation of PCM devices facilitates non-von Neumann computing architectures that enable in-memory computing capabilities. Generally speaking, traditional computing architectures include a central processing unit (CPU) communicatively connected to one or more memory devices via a bus. As such, a finite amount of energy and time is consumed to transfer data between the CPU and memory, which is a known bottleneck of von Neumann's computing architectures. However, PCM devices minimize and, in some cases, eliminate data transfers between the CPU and memory by performing some computing operations in memory. Stated differently, PCM devices both store information and execute computational tasks. Such non-von Neumann computing architectures may implement vectors having a relatively high dimensionality to facilitate hyperdimensional computing, such as vectors having 10,000 bits. Relatively large bit width vectors enable computing paradigms modeled after the human brain, which also processes information analogous to wide bit vectors.

The compute circuitry 902 is communicatively coupled to other components of the compute node 900 via the I/O subsystem 908, which may be embodied as circuitry and/or components to facilitate input/output operations with the compute circuitry 902 (e.g., with the processor 904 and/or the main memory 906) and other components of the compute circuitry 902. For example, the I/O subsystem 908 may be embodied as, or otherwise include memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 908 may form a portion of a system-on-a-chip (SoC) and be incorporated, along with one or more of the processor 904, the memory 906, and other components of the compute circuitry 902, into the compute circuitry 902.

One or more data storage devices 910 may be embodied as any type of device configured for short-term or long-term storage of data such as, for example, memory devices and circuits, memory cards, hard disk drives, solid-state drives, or other data storage devices. Individual data storage devices may include a system partition that stores data and firmware code for the one or more data storage devices 910. Individual data storage devices of the one or more data storage devices 910 may also include one or more operating system partitions that store data files and executables for operating systems depending on, for example, the type of compute node 900.

The communication circuitry subsystem 912 may be embodied as any communication circuit, device, or collection thereof, capable of enabling communications over a network between the compute circuitry 902 and another compute device (e.g., an edge gateway of an implementing edge computing system). The communication circuitry subsystem 912 may be configured to use any one or more communication technology (e.g., wired or wireless communications) and associated protocols (e.g., a cellular networking protocol such as a 3GPP 4G or 5G standard, a wireless local area network protocol such as IEEE 802.11/Wi-Fi®, a wireless wide area network protocol, Ethernet, Bluetooth®, Bluetooth Low Energy, an IoT protocol such as IEEE 802.15.4 or ZigBee®, low-power wide-area network (LPWAN) or low-power wide-area (LPWA) protocols, etc.) to effect such communication.

The illustrative communication circuitry subsystem 912 includes a network interface controller (NIC) 920, which may also be referred to as a host fabric interface (HFI). The NIC 920 may be embodied as one or more add-in-boards, daughter cards, network interface cards, controller chips, chipsets, or other devices that may be used by the compute node 900 to connect with another compute device (e.g., an edge gateway node). In some examples, the NIC 920 may be embodied as part of a system-on-a-chip (SoC) that includes one or more processors or included on a multichip package that also contains one or more processors. In some examples, the NIC 920 may include a local processor (not shown) and/or a local memory (not shown) that are both local to the NIC 920. In such examples, the local processor of the NIC 920 may be capable of performing one or more of the functions of the compute circuitry 902 described herein. Additionally, or in such examples, the local memory of the NIC 920 may be integrated into one or more components of the client compute node at the board level, socket level, chip level, and/or other levels.

Additionally, in some examples, a respective compute node 900 may include one or more peripheral devices 914. Such peripheral devices 914 may include any type of peripheral device found in a compute device or server such as audio input devices, a display, other input/output devices, interface devices, and/or other peripheral devices, depending on the particular type of the compute node 900. In further examples, the compute node 900 may be embodied by a respective edge compute node (whether a client, gateway, or aggregation node) in an edge computing system or forms of appliances, computers, subsystems, circuitry, or other components.

In a more detailed example, FIG. 9B illustrates a block diagram of an example of components that may be present in an edge computing node 950 for implementing the techniques (e.g., operations, processes, methods, and methodologies) described herein. This edge computing node 950 provides a closer view of the respective components of node 900 when implemented as or as part of a computing device (e.g., as a mobile device, a base station, server, gateway, etc.). The edge computing node 950 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 950, or as components otherwise incorporated within a chassis of a larger system.

The edge computing node 950 may include processing circuitry in the form of a processor 952, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 952 may be a part of a system on a chip (SoC) in which the processor 952 and other components are formed into a single integrated circuit, or a single package, such as the Edison™ or Galileo™ SoC boards from Intel Corporation, Santa Clara, California. As an example, the processor 952 may include an Intel® Architecture Core™ based CPU processor, such as a Quark™, an Atom™, an i3, an i5, an i7, an i9, or an MCU-class processor, or another such processor available from Intel®. However, any number of other processors may be used, such as available from Advanced Micro Devices, Inc. (AMD®) of Sunnyvale, California, a MIPS®-based design from MIPS Technologies, Inc. of Sunnyvale, California, an ARM®-based design licensed from ARM Holdings, Ltd. or a customer thereof, or their licensees or adopters. The processors may include units such as an A5-A15 or M1/M2 processor from Apple® Inc., a Snapdragon™ processor from Qualcomm® Technologies, Inc., or an OMAP™ processor from Texas Instruments, Inc. The processor 952 and accompanying circuitry may be provided in a single socket form factor, multiple socket form factor, or a variety of other formats, including in limited hardware configurations or configurations that include fewer than all elements shown in FIG. 9B.

The processor 952 may communicate with a system memory 954 over an interconnect 956 (e.g., a bus). Any number of memory devices may be used to provide for a given amount of system memory. As an example, the memory 954 may be random access memory (RAM) per a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP), or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems, and so forth, a storage 958 may also couple to the processor 952 via the interconnect 956. In an example, storage 958 may be implemented via a solid-state disk drive (SSDD). Other devices that may be used for the storage 958 include flash memory cards, such as Secure Digital (SD) cards, microSD cards, extreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin-transfer torque (STT)-MRAM, a spintronic magnetic junction memory-based device, a magnetic tunneling junction (MTJ) based device, a DW (Domain Wall) and SOT (Spin-Orbit Transfer) based device, a thyristor-based memory device, or a combination of any of the above, or other memory.

In low-power implementations, the storage 958 may be on-die memory or registers associated with the processor 952. However, in some examples, storage 958 may be implemented using a micro hard disk drive (HDD). Further, any number of new technologies may be used for the storage 958 in addition to, or instead of, the technologies described, such as resistance change memories, phase change memories, holographic memories, or chemical memories, among others.

The components may communicate over the interconnect 956. The interconnect 956 may include any number of technologies, including industry-standard architecture (ISA), extended ISA (EISA), peripheral component interconnect (PCI), peripheral component interconnect extended (PCI-X), PCI express (PCIe), or any number of other technologies. The interconnect 956 may be a proprietary bus, for example, used in an SoC-based system. Other bus systems may be included, such as an Inter-Integrated Circuit (I2C) interface, a Serial Peripheral Interface (SPI) interface, point-to-point interfaces, and a power bus, among others.

The interconnect 956 may couple the processor 952 to a transceiver 966 (e.g., a wireless network transceiver), for communications with the connected edge devices 962. The transceiver 966 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 962. For example, a wireless local area network (WLAN) unit may be used to implement Wi-Fi® communications under the Institute of Electrical and Electronics Engineers (IEEE) 802.11 standard. Also, wireless wide area communications, e.g., according to a cellular or other wireless wide area protocol, may occur via a wireless wide area network (WWAN) unit.

The wireless network transceiver 966 (or multiple transceivers) may communicate using multiple standards or radios for communications at a different range. For example, the edge computing node 950 may communicate with close devices, e.g., within about 10 meters, using a local transceiver based on Bluetooth Low Energy (BLE), or another low-power radio, to save power. More distant connected edge devices 962, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 966 (e.g., a radio transceiver) may be included to communicate with devices or services in the edge cloud 995 via local or wide-area network protocols. The wireless network transceiver 966 may be a low-power wide-area (LPWA) transceiver that follows the IEEE 802.15.4, or IEEE 802.15.4g standards, among others. The edge computing node 950 may communicate over a wide area using LoRaWAN™ (Long Range Wide Area Network) developed by Semtech and the LoRa Alliance. The techniques described herein are not limited to these technologies but may be used with any number of other cloud transceivers that implement long-range, low-bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 966, as described herein. For example, the transceiver 966 may include a cellular transceiver that uses spread spectrum (SPA/SAS) communications for implementing high-speed communications. Further, any number of other protocols may be used, such as Wi-Fi® networks for medium-speed communications and provision of network communications. The transceiver 966 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 968 may be included to provide wired communication to nodes of the edge cloud 995 or other devices, such as the connected edge devices 962 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 968 may be included to enable connecting to a second network, for example, a first NIC 968 providing communications to the cloud over Ethernet, and a second NIC 968 providing communications to other devices over another type of network.

Given the variety of types of applicable communications from the device to another component or network, applicable communications circuitry used by the device may include or be embodied by any one or more of circuitry 964, transceiver 966, NIC 968, or interface 970. Accordingly, in various examples, applicable means for communicating (e.g., receiving, transmitting, etc.) may be embodied by such communications circuitry.

The edge computing node 950 may include or be coupled to acceleration circuitry 964, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 956 may couple the processor 952 to a sensor hub or external interface 970 that is used to connect additional devices or subsystems. The devices may include sensors 972, such as accelerometers, level sensors, flow sensors, optical light sensors, camera sensors, temperature sensors, global navigation system (e.g., GPS) sensors, pressure sensors, barometric pressure sensors, and the like. The sensor hub or external interface 970 further may be used to connect the edge computing node 950 to actuators 974, such as power switches, valve actuators, an audible sound generator, a visual warning device, and the like.

In some optional examples, various input/output (I/O) devices may be present within or connected to, the edge computing node 950. For example, a display or other output device 984 may be included to show information, such as sensor readings or actuator position. An input device 986, such as a touch screen or keypad may be included to accept input. An output device 984 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 950. A display or console hardware, in the context of the present system, may be used to provide output and receive input of an edge computing system; to manage components or services of an edge computing system; identify a state of an edge computing component or service, or to conduct any other number of management or administration functions or service use cases.

A battery 976 may power the edge computing node 950, although, in examples in which the edge computing node 950 is mounted in a fixed location, it may have a power supply coupled to an electrical grid, or the battery may be used as a backup or for temporary capabilities. The battery 976 may be a lithium-ion battery, or a metal-air battery, such as a zinc-air battery, an aluminum-air battery, a lithium-air battery, and the like.

A battery monitor/charger 978 may be included in the edge computing node 950 to track the state of charge (SoCh) of the battery 976 (when included). The battery monitor/charger 978 may be used to monitor other parameters of the battery 976 to provide failure predictions, such as the state of health (SoH) and the state of function (SoF) of the battery 976. The battery monitor/charger 978 may include battery monitoring integrated circuits, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 978 may communicate the information on battery 976 to the processor 952 over the interconnect 956. The battery monitor/charger 978 may also include an analog-to-digital (ADC) converter that enables the processor 952 to directly monitor the voltage of battery 976 or the current flow from battery 976. The battery parameters may be used to determine actions that the edge computing node 950 may perform, such as transmission frequency, mesh network operation, sensing frequency, and the like.

A power block 980, or other power supply coupled to a grid, may be coupled with the battery monitor/charger 978 to charge the battery 976. In some examples, the power block 980 may be replaced with a wireless power receiver to obtain the power wirelessly, for example, through a loop antenna in the edge computing node 950. A wireless battery charging circuit, such as an LTC4020 chip from Linear Technologies of Milpitas, California, among others, may be included in the battery monitor/charger 978. The specific charging circuits may be selected based on the size of the battery 976, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

Storage 958 may include instructions 982 in the form of software, firmware, or hardware commands to implement the techniques described herein. Although such instructions 982 are shown as code blocks included in memory 954 and storage 958, it may be understood that any of the code blocks may be replaced with hardwired circuits, for example, built into an application-specific integrated circuit (ASIC).

In an example, the instructions 982 provided via the memory 954, the storage 958, or the processor 952 may be embodied as a non-transitory, machine-readable medium 960 including code to direct the processor 952 to perform electronic operations in the Edge computing node 950. Processor 952 may access the non-transitory, machine-readable medium 960 over the interconnect 956. For instance, the non-transitory, machine-readable medium 960 may be embodied by devices described for the storage 958 or may include specific storage units such as storage devices and/or storage disks that include optical disks (e.g., digital versatile disk (DVD), compact disk (CD), CD-ROM, Blu-ray disk), flash drives, floppy disks, hard drives (e.g., SSDs), or any number of other hardware devices in which information is stored for any duration (e.g., for extended periods, permanently, for brief instances, for temporarily buffering, and/or caching). The non-transitory, machine-readable medium 960 may include instructions to direct the processor 952 to perform a specific sequence or flow of actions, for example, as described concerning the flowchart(s) and block diagram(s) of operations and functionality depicted above. As used herein, the terms “machine-readable medium”, “computer-readable medium”, “machine-readable storage”, and “computer-readable storage” are interchangeable. As used herein, the term “non-transitory computer-readable medium” is expressly defined to include any type of computer-readable storage device and/or storage disk to exclude propagating signals and to exclude transmission media.

Also in a specific example, instructions 982 on processor 952 (separately, or in combination with instructions 982 of the machine-readable medium 960) may configure execution or operation of a trusted execution environment (TEE) 990. In an example, the TEE 990 operates as a protected area accessible to processor 952 for secure execution of instructions and secure access to data. Various implementations of the TEE 990, and an accompanying secure area in the processor 952 or the memory 954 may be provided, for instance, through the use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in edge computing node 950 through the TEE 990 and the processor 952.

While the illustrated examples of FIG. 9A and FIG. 9B includes example components for a compute node and a computing device, respectively, examples disclosed herein are not limited thereto. As used herein, a “computer” may include some or all of the example components of FIGS. 9A and/or 9B in different types of computing environments. Example computing environments include Edge computing devices (e.g., Edge computers) in a distributed networking arrangement such that particular ones of participating Edge computing devices are heterogeneous or homogeneous devices. As used herein, a “computer” may include a personal computer, a server, user equipment, an accelerator, etc., including any combinations thereof. In some examples, distributed networking and/or distributed computing includes any number of such Edge computing devices as illustrated in FIGS. 9A and/or 9B, which may include different sub-components, different memory capacities, I/O capabilities, etc. For example, because some implementations of distributed networking and/or distributed computing are associated with the particular desired functionality, examples disclosed herein include different combinations of components illustrated in FIGS. 9A and/or 9B to satisfy functional objectives of distributed computing tasks. In some examples, the term “compute node” or “computer” only includes the example processor 904, memory 906, and I/O subsystem 908 of FIG. 9A. In some examples, one or more objective functions of a distributed computing task(s) rely on one or more alternate devices/structures located in different parts of an Edge networking environment, such as devices to accommodate data storage (e.g., the one or more data storage devices 910), input/output capabilities (e.g., the example peripheral device(s) 914), and/or network communication capabilities (e.g., the example NIC 920).

In some examples, computers operating in a distributed computing and/or distributed networking environment (e.g., an Edge network) are structured to accommodate particular objective functionality in a manner that reduces computational waste. For instance, because a computer includes a subset of the components disclosed in FIGS. 9A and 9B, such computers satisfy the execution of distributed computing objective functions without including computing structures that would otherwise be unused and/or underutilized. As such, the term “computer” as used herein includes any combination of the structure of FIGS. 9A and/or 9B that is capable of satisfying and/or otherwise executing objective functions of distributed computing tasks. In some examples, computers are structured in a manner commensurate to corresponding distributed computing objective functions in a manner that downscales or upscales in connection with dynamic demand. In some examples, different computers are invoked and/or otherwise instantiated given their ability to process one or more tasks of the distributed computing request(s), such that any computer capable of satisfying the tasks proceeds with such computing activity.

In the illustrated examples of FIGS. 9A and 9B, computing devices include operating systems. As used herein, an “operating system” is software to control example computing devices, such as the example Edge compute node 900 of FIG. 9A and/or the example Edge compute node 950 of FIG. 9B. Example operating systems include, but are not limited to consumer-based operating systems (e.g., Microsoft® Windows® 11, Google® Android® OS, Apple® Mac® OS, etc.). Example operating systems also include, but are not limited to industry-focused operating systems, such as real-time operating systems, hypervisors, etc. An example operating system on a first Edge compute node may be the same or different than an example operating system on a second Edge compute node. In some examples, the operating system invokes alternate software to facilitate one or more functions and/or operations that are not native to the operating system, such as particular communication protocols and/or interpreters. In some examples, the operating system instantiates various functionalities that are not native to the operating system. In some examples, operating systems include varying degrees of complexity and/or capabilities. For instance, a first operating system corresponding to a first Edge compute node includes a real-time operating system having particular performance expectations of responsivity to dynamic input conditions, and a second operating system corresponding to a second Edge compute node includes graphical user interface capabilities to facilitate end-user I/O.

In further examples, a non-transitory machine-readable medium (e.g., a computer-readable medium) also includes any medium (e.g., storage device, storage disk, etc.) that is capable of storing, encoding, or carrying instructions for execution by a machine that causes the machine to perform any one or more of the methodologies of the present disclosure or that is capable of storing, encoding or carrying data structures utilized by or associated with such instructions. A “non-transitory machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks (e.g., SSDs); magneto-optical disks; and CD-ROM and DVD-ROM disks. The instructions embodied by a machine-readable medium may further be transmitted or received over a communications network using a transmission medium via a network interface device utilizing any one of several transfer protocols (e.g., Hypertext Transfer Protocol (HTTP)).

A machine-readable medium may be provided by a storage device or other apparatus which is capable of hosting data in a non-transitory format. As used herein, the term non-transitory computer-readable medium is expressly defined to include any type of computer-readable storage device and/or storage disk to exclude propagating signals and to exclude transmission media. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

FIG. 9C illustrates an example software distribution platform 996 to distribute software, such as the example computer-readable instructions 999, to one or more devices, such as processor platform(s) 998 and/or example connected edge devices 962 of FIG. 9B. The example software distribution platform 996 may be implemented by any computer server, data facility, cloud service, etc., capable of storing and transmitting software to other computing devices (e.g., third parties, the example connected edge devices 962 of FIG. 9B). Example connected edge devices may be customers, clients, managing devices (e.g., servers), third parties (e.g., customers of an entity owning and/or operating the software distribution platform 996). Example connected edge devices may operate in commercial and/or home automation environments. In some examples, a third party is a developer, a seller, and/or a licensor of software such as the example computer-readable instructions 999. The third parties may be consumers, users, retailers, OEMs, etc. that purchase and/or license the software for use and/or re-sale and/or sub-licensing. In some examples, distributed software causes the display of one or more user interfaces (UIs) and/or graphical user interfaces (GUIs) to identify the one or more devices (e.g., connected edge devices) geographically and/or logically separated from one another (e.g., physically separated IoT devices chartered with the responsibility of water distribution control (e.g., pumps), electricity distribution control (e.g., relays), etc.).

In the illustrated example of FIG. 9C, the software distribution platform 996 includes one or more servers and one or more storage devices. The storage devices store the computer-readable instructions 999, which may correspond to the example computer-readable instructions 982 of FIG. 9B, as described above. One or more servers of the example software distribution platform 996 are in communication with network 997, which may correspond to any one or more of the Internet and/or any of the example networks described herein. In some examples, one or more servers are responsive to requests to transmit the software to a requesting party as part of a commercial transaction. Payment for the delivery, sale, and/or license of the software may be handled by one or more servers of the software distribution platform and/or via a third-party payment entity. The servers enable purchasers and/or licensors to download the computer-readable instructions 999 from the software distribution platform 996. For example, the software may correspond to the example computer-readable instructions 982 of FIG. 9B, may be downloaded to the example processor platform(s) 998 (e.g., example connected edge devices), which is/are to execute the computer-readable instructions 999 to implement the techniques discussed herein. In some examples, one or more servers of the software distribution platform 996 are communicatively connected to one or more security domains and/or security devices through which requests and transmissions of the example computer-readable instructions 999 must pass. In some examples, one or more servers of the software distribution platform 996 periodically offer, transmit, and/or force updates to the software (e.g., the example computer-readable instructions 982 of FIG. 9B which can be the same as the computer-readable instructions 999) to ensure improvements, patches, updates, etc. are distributed and applied to the software at the end-user devices.

In the illustrated example of FIG. 9C, the computer-readable instructions 999 are stored on storage devices of the software distribution platform 996 in a particular format. A format of computer-readable instructions includes, but is not limited to a particular code language (e.g., Java, JavaScript, Python, C, C#, SQL, HTML, etc.), and/or a particular code state (e.g., uncompiled code (e.g., ASCII), interpreted code, linked code, executable code (e.g., a binary), etc.). In some examples, the computer-readable instructions 999 stored in the software distribution platform 996 are in a first format when transmitted to the example processor platform(s) 996. In some examples, the first format is an executable binary in which particular types of processor platform(s) 998 can execute. However, in some examples, the first format is uncompiled code that uses one or more preparation tasks to transform the first format to a second format to enable execution on the example processor platform(s) 998. For instance, the receiving processor platform(s) 998 may need to compile the computer-readable instructions 999 in the first format to generate executable code in a second format that is capable of being executed on the processor platform(s) 998. In still other examples, the first format is interpreted code that, upon reaching the processor platform(s) 998, is interpreted by an interpreter to facilitate the execution of instructions.

### ETSI MEC and 3GPP SA6 Architectures and Components

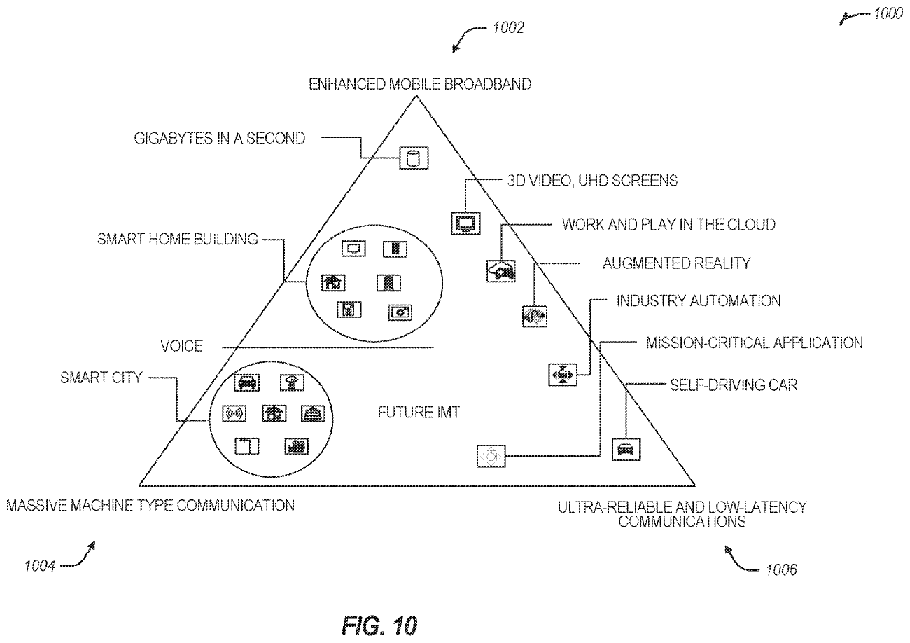

FIG. 10 illustrates an overview of 5G networking 1000, depicting the coexistence of different types of applications and quality of service requirements, according to some examples. FIG. 10 shows an overview of a 5G (and beyond) International Mobile Telecommunications (IMT) network 1000 that is optimized for the coexistence of three classes of applications with differing quality-of-service (QoS) requirements: (1) enhanced Mobile Broadband (eMBB) 1002 for meeting increased user demands for a digital lifestyle associated with high requirements for the bandwidth supporting ultra-HD, virtual reality (VR), and augmented reality (AR) applications; (2) massive machine-type communications (mMTC) 1004 for meeting digitized societal demands in supporting scenarios with high-density connections such as intelligent transportation, and smart manufacturing; and (3) Ultra-reliable low-latency communications (URLLC) 1006 for meeting enterprise and high-end market requirements for smart industries, mission-critical service, autonomous/remote driving, and the like that have stringent latency and ultra-high connection reliability requirements.

5G networks, as well as the next generation of mobile networks, are important for enabling future digital communication improvements including the support for the digitalization of vertical industries (such as transportation, logistics, automated driving, healthcare, manufacturing, energy, and media, and entertainment), and the development of public utilities (such as smart city, public security, and education). One approach to enable differentiated services in 5G and future IMT networks for diverse verticals is through different edge applications and corresponding application management systems such as the disclosed ENMS and associated applications.

FIG. 11 illustrates a network architecture 1100, providing a synergized version that incorporates the MEC federation variant of the reference MEC architecture and the 3GPP EDGEAPP architecture, according to some examples. This network architecture 1100 specifically supports different modes of operations while leveraging 3GPP (SA6 EDGEAPP) and ETSI ISG MEC (see, e.g., ETSI White Paper #36, “Harmonizing standards for edge computing—A synergized architecture leveraging ETSI ISG MEC and 3GPP specification”, 1st Ed., ISBN No. 979-10-92620-35-5 (July 2020)). FIG. 11 further illustrates an adaptation of this synergized version of a network architecture, taking into account the MEC Federation variant of the reference MEC architecture and the 3GPP EDGEAPP architecture such as specified in 3GPP TS 23.558 v17.0.0 (2021 Jun. 28).

On the left side of FIG. 11, devices (e.g., UE 1120) run application clients (e.g., application client 1121) that either use the DNS to discover application servers (e.g., Edge Application Server 1124 (EAS) in 3GPP SA6 terminology or MEC Application 1126 in ETSI ISG MEC terminology) or use an Edge Enabler Client 1122 (EEC) to perform the discovery according to the SA6 EDGEAPP architecture. Towards the middle of FIG. 11, a platform (Edge Enabler Server 1134 (EES) in 3GPP SA6 and MEC Platform 1132 in ETSI ISG MEC) provide functionality pertaining to mediating access to network services, application authorization, application's service registration and application's service discovery, context transfer, etc., for a host such as MEC Host 1102 or other entities. A given implementation can combine functions specified by ETSI ISG MEC and functions specified by 3GPP SA6. The platform typically exposes APIs towards edge cloud applications (such as the MEC Application 1126 or the Edge Application Server 1124). EDGE-3 and Mp1 offer complementary API functions, therefore can be considered to be part of a single reference point from an application developer perspective. Towards the right of FIG. 11, functionalities specified by ETSI ISG MEC include management and orchestration of the MEC platforms (e.g., via MEC platform manager 1106, MEC orchestrator 1110, MEC federator 1107) and OSS functions (e.g., from an operations support system 1112) supporting access to portals offered to application service providers (e.g., user application LCM proxy 1114 to device app 1118, or CFS portal 1116).

EDGE-3 and Mp1 interfaces provide service registration and service discovery features that enable an edge cloud application to register services exposed by this application and their subsequent discovery and use by other applications. The exposed services may relate to network services, subject to their availability at the core or access network level. The common capabilities may be harmonized through adoption of the Common API Framework (CAPIF) such as specified in 3GPP TS 23.222 v17.5.0 (2021 Jun. 24). EDGE-9 and Mp3 interfaces are being developed to assist in context migration. Other interfaces including EDGE-2, EDGE-7, EDGE-8, and M3GPP-1 may provide an endorsement of SA2 interfaces (e.g., Network Exposure Function/Service Capability Exposure Function, NEF/SCEF), According to 3GPP SA6 specifications, edge services are exposed to the application clients by the Edge Configuration Server 1140 (ECS) and Edge Enabler Server 1134 (EES) via the Edge Enabler Client 1122 (EEC) in the UE. A respective EEC is configured with the address of the ECS, which is provided by either the MNO or by the Edge Computing Service Provider. Deployment options discussed in ETSI White Paper #36, “Harmonizing standards for edge computing-A synergized architecture leveraging ETSI ISG MEC and 3GPP specifications”, July 2020, may implement all or a subset of the features of this or a similar synergized architecture, as discussed in the following sections.

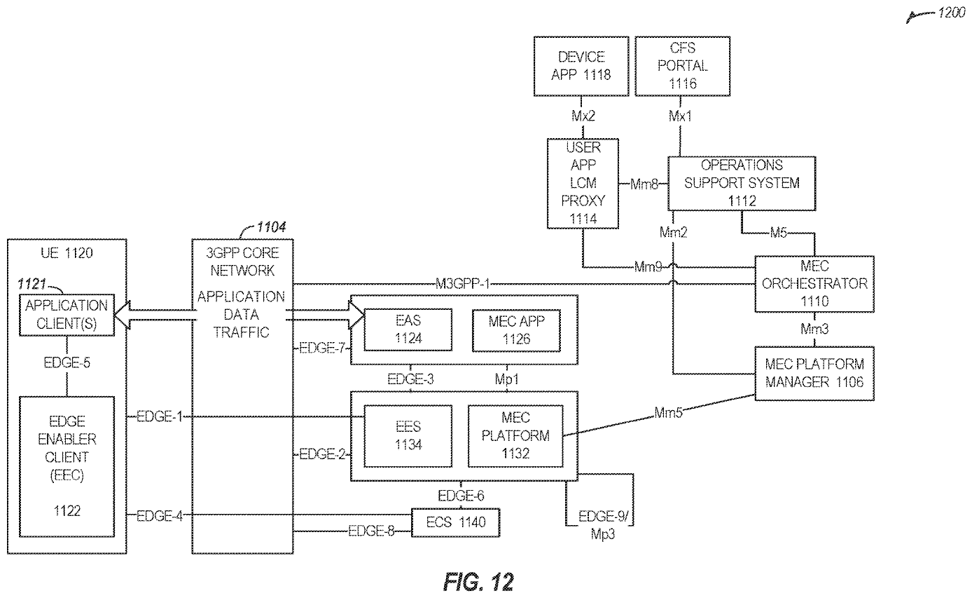

FIG. 12 illustrates an architecture 1200 leveraging additional interfaces provided with ETSI ISG MEC and 3GPP (SA6 EDGEAPP) specifications, according to some examples. For instance, see the EDGE-3 and Mp1 interfaces depicted between Edge Application Server 1124 or MEC Application 1126 and Edge Enabler Server 1134 or MEC Platform 1132, The MEC system deployed in 3GPP networks can be considered an evolution of current 5G edge deployments, where EDGEAPP and ETSI MEC systems are aligned. In some examples, the disclosed configurations can be used in connection with a converged architecture such as illustrated in FIG. 12.

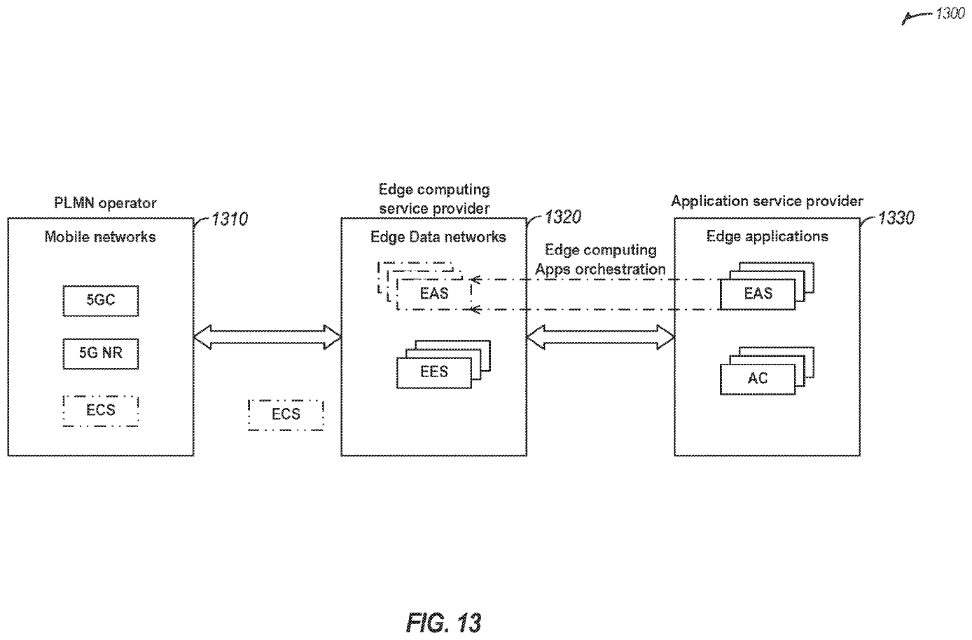

FIG. 13 illustrates communications 1300 between a PLMN operator 1310, an edge computing service provider 1320, and an application service provider 1330, according to some examples. In an example configuration, the 5G Core (5GC) is in the PLMN domain, while EDGEAPP entities like EES and EAS are outside this domain. For instance, according to 3GPP (e.g., TR-28.814), the 5GC may be in the PLMN domain of mobile networks, while 3GPP EDGEAPP entities like Edge Enabler Server (EES) (e.g., hosted at an edge computing service provider) and Edge Application Server (EAS) (e.g., hosted by an application service provider) are outside this domain.

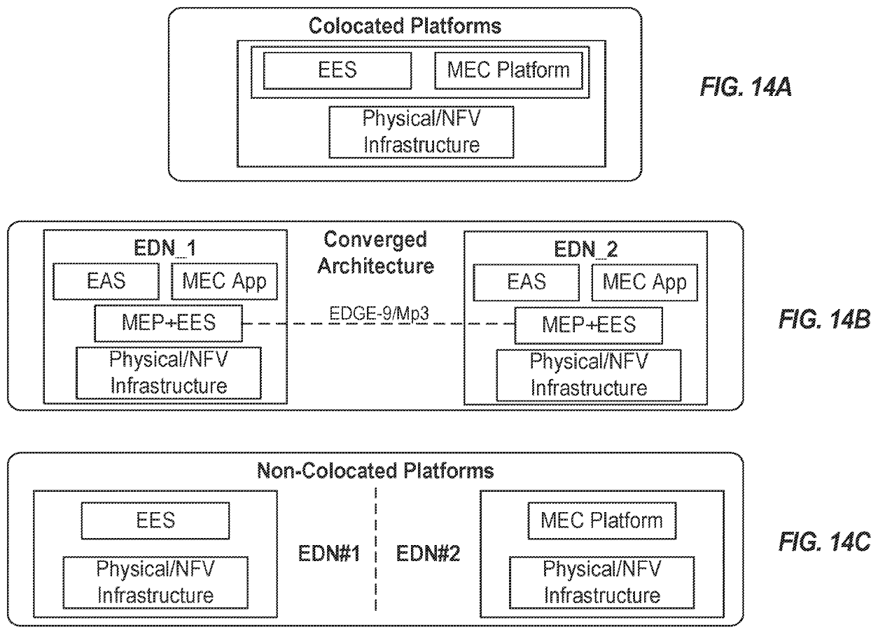

FIGS. 14A, 14B, and 14C illustrate respective MEC deployment options, according to some examples. A MEC deployment following these scenarios can be seen in FIG. 13 as outside of the PLMN domain (in the most general case). In this context the MEC App is equivalent to an EAS and can consume APIs from the underlying edge platform (MEP/EES, referring to MEC Platform or Edge Enabler Server). However, such examples are not limiting and other deployment options can be considered.

In FIG. 14A, a co-located platform is depicted that includes an EES and MEC Platform. The two platforms (EES and MEC Platform) are co-located, and made by a single (e.g., unique) equipment, which is compliant with both standards. However, they are seen as two different application functions (AFs) on a single physical or NFV infrastructure.

In FIG. 14B, a converged architecture is depicted between a first and a second edge data network (EDN) denoted as EDN_1 and EDN_2. MEP and EES are able to satisfy the functionalities of MEP defined in ETSI standards and EES defined in SA6 standards. A uniform API may be defined for the EAS and MEC app, such as by unifying EDGE-3 and Mp1 into one interface. This enables the EAS and MEC app to consume the same service from the MEP+EES. Additionally, EDGE-9 and MP3 may be unified into one interface.

In FIG. 14C, a non-co-located platform is depicted between a first and second EDN denoted as EDN #1 and EDN #2. The two platforms are not co-located and reside in two different data networks, where EES is in the mobile network operator (MNO) domain and the ETSI MEC platform is in another MNO domain. They are seen as two different AFs in two different EDNs.

In further examples, the use or configuration of a MEC Federation can also be used with the techniques discussed herein. The GSMA OPG (Operator Platform Group) defines a series of technical requirements to establish a MEC Federation among different operators and partners. The disclosed techniques can be used in connection with a MEC Federation reference scenario, where multiple operators and partners are collaborating by exposing their edge computing capabilities and resources, and where application developers and customers (managing environments typically external to the PLMN trust domains) have managing applications workloads that could be also in the operator domains.

### MEC Application Management Via an ENMS

In the context of MEC deployments with 5G or other 3GPP implementations, the techniques discussed herein address a use case where a third-party edge computing service provider (ECSP) intends to manage MEC app deployments and their traffic flows. This mechanism can be trusted by the MNO, even if the management is performed outside of a PLMN trusted domain. In this context, the techniques discussed herein can be used by a MEC App to provide a service acting as a proxy (e.g., running in the ECSP domain) for handling and manipulating the network packets of other MEC Apps in the same ECSP domain (e.g., via changing traffic rules).

In an example implementation, four aspects are introduced that can be configured as part of an ENMS or similar edge-native management functions/implementations:
(a) A traffic manipulator MEC App, seen as an external AF by the 5G System. This app is exposed via a common API framework (CAPIF) (e.g., similar to other AFs in MEC) to EESs and MEC platforms, and is deployed as a smart application including an “Edge-Native SMF Engine” (ENSE) implementation, with “SMF” referring to a “Session Management Function.” In a specific example related to 3GPP networks, the ENSE application (“ENSE App”) is a virtualized implementation of an SMF, operating in a MEC environment or system (which in general is located outside the PLMN domain), and may be also managed by a third-party ECSP.
(b) One or more messages between the ENSE application and the MEC platform, where the ENSE application instructs the MEC platform to change the traffic routing of a target MEC app (e.g., the traffic flow between a certain UE and the target MEC app).
(c) One or more signaling flows involving the ENSE application, the 3GPP management system (e.g., via queries to the NEF), and the northbound interface (NBI) consumer at the edge computing service provider (ECSP) (e.g., via the MEC orchestrator) for supporting the joint instantiation of a network slice and MEC application slice. As a result of this interaction, the ENSE application will be able to influence the traffic flow between a certain UE and the target MEC app—in both directions—to jointly satisfy network slice and MEC application slice requirements. In an example, a NBI consumer at a (third party) ECSP domain represents a customer-side use (e.g., from a vertical segment) and is generally referred to as a “client” hereinafter.
(d) A MEC API made available in Mp1 for the application developer, which is also relevant as operator platform NBI (OP-NBI) as well as other MEC APIs via Mp1. This MEC API can be used to influence the traffic rules of a target MEC app, and also to support the instantiation of a respective network slice and MEC application slice.

The disclosed techniques provide a “traffic manipulator” MEC application, which could consume information, such as for example, current network conditions (exposed via the Radio Network Information-RNI API), QoS predictions, UE location information exposed by the location API. This MEC application can decide (or not) whether to activate, deactivate, or update traffic rules and implement them for QoS enhancement of the MEC application instance (e.g., the MEC application instance that carriers the “pure” application workload/logic).

The techniques herein may have an impact on standards (e.g., studies and definitions of on MEC App slices, e.g., provided in ETSI GR MEC 044) and future normative work (e.g., for defining properly some messages and data types). The standard support in MEC (e.g., Annex A.3 of ETSI GS MEC 003) may provide the possibility for a MEC application to manage to manipulate (e.g., filtering, routing, tapping) the IP traffic of the same MEC application instance, not another one. A possibility to control the RAN is to jointly deploy RAN intelligent controller (RIC) and MEC systems under a unified platform, and instantiate an xApp and a MEC app that can dialogue, or a hybrid app that could serve for both RIC and MEC systems. Nevertheless, this configuration is resolving one issue (RAN configuration) and a 3GPP-compliant solution to manage traffic rules is not present yet in the standard. Further, in the disclosed techniques, this may cause an impact on both the network slice and MEC application slice.

The following techniques provide a definition for manipulating (e.g., filtering, routing, tapping) the IP traffic of different MEC applications, from a non-trusted domain management entity. These techniques can enable a complete approach for E2E management of both the network slice and MEC application slice. These techniques can also be used for configuring a management engine that can be run by third parties (e.g., not by the MNO), with implications on agreements and collaborations between MNO and verticals or other customers. In particular, the following use of an ENSE application may help in controlling the traffic conditions related to the SLA between MNO and external parties. The disclosed techniques can also be used to enable an interoperable software instance between different entities in the space of edge computing.

In some aspects, the disclosed techniques introduce new messages and signaling in compliance with (and potentially as defined by) the ETSI MEC standard. For example, uses of the following API will assist products implementing a MEC platform or even MEC applications using that API. Additionally, software implementations of the following ENSE application may be used by service providers and edge computing system integrators. The following API introduces messages that can be detected in the 5GS service bus, including from the ENSE application and the NEF, and also directly between the new reference point between the ENSE application and the MEC platform, for the setup and configuration of the traffic rules.

The following sections provide details on the following aspects of the ENMS and its functions: (a) Definition of the “Edge-Native SMF Engine” (ENSE); (b) Messages between this ENSE application and the MEC Platform; (c) Signaling flow involving the ENSE application, the 3GPP management system, and the ECSP (via MEC system management); and (d) Introduction of an MEC edge-native session management (ENSM) service API. This discussion is followed by a list of implementing methods, devices, and examples for these aspects.

### Definition of an “Edge-Native SMF Engine” (ENSE)

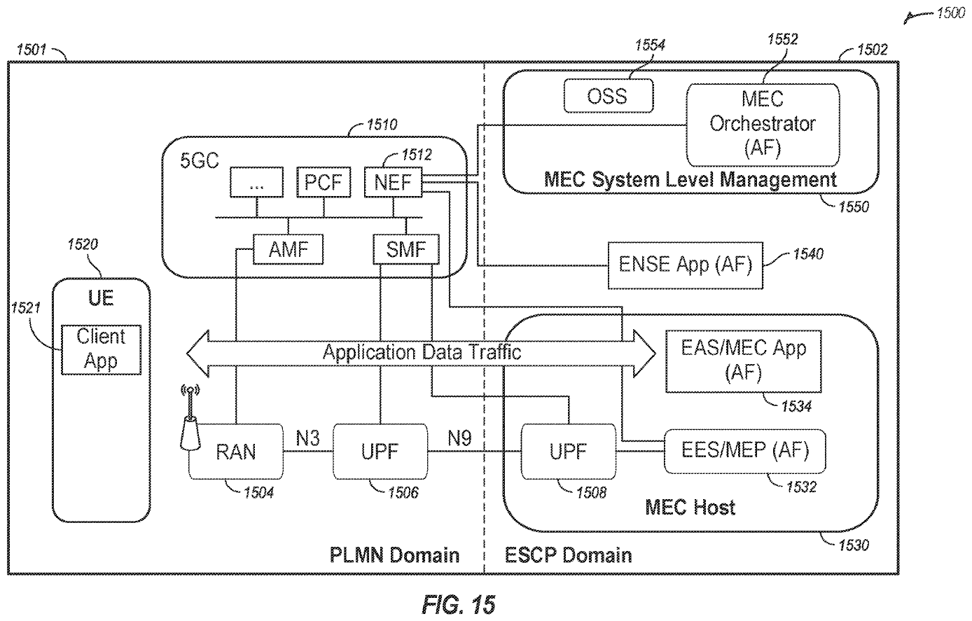

FIG. 15 illustrates a system 1500 deploying an Edge-Native SMF Engine (ENSE) application 1540, according to some examples. In this system 1500, 3GPP functions such as a RAN 1504, UPF 1506, and 5GC 1510 operate in a PLMN Domain 1501, providing connectivity and application data traffic with a UE 1520 and its client applications (e.g., Client APP 1521). The PLMN Domain 1501 is connected to the ESCP Domain 1502 via a UPF 1506 and a UPF 1508, via the interfaces shown (and other interfaces not shown). The application data traffic is directed to a MEC App 1534 of a MEC host 1530 (or, to an equivalent EAS application for a 3GPP EDGEAPP system).

The ENSE APP 1540 operates (e.g., is executing or running) in the ECSP Domain 1502, but the ENSE APP 1540 is not necessarily running on the MEC host 1530. Rather, system 1500 depicts a general deployment, where the ENSE APP 1540 is running somewhere in the ECSP Domain 1502 (and is not necessarily co-located with the MEC Orchestrator (MEO) 1552, OSS 1554, or other MEC system level management 1550). Although a general scenario is depicted, the ENSE APP 1540 and similar engines may be entitled to manage multiple connections (e.g., also potentially pertaining to many UEs).

In the system 1500, a traffic manipulator MEC app is defined as ENSE APP 1540. The ENSE APP 1540 is as an external AF by the 5G system, and is exposed via CAPIF (as the rest of other AFs in MEC) to EESs and MEC platforms (e.g., EES or MEP 1532) and deployed as smart application including an ENSE implementation. In connection with an example related to 3GPP networks, the ENSE APP 1540 is a virtualized implementation of an SMF, sitting on MEC (which in general is located outside the PLMN domain) and possibly also managed by a third-party ECSP.

In an example, application traffic filtering and routing configurations of the system 1500 may include or integrate application traffic filtering and routing techniques. The MEC platform (e.g., MEP 1532) may allow the activation, update, and deactivation of the MEC application traffic rules, and apply these rules to the underlying data plane. This allows IP traffic routing or tapping to the MEC applications or to locally accessible networks (e.g., enterprise network, Internet access, etc.) according to the configured traffic rules. Within the constraints set by the MEC management, an authorized MEC application can request the activation, update, and deactivation of the MEC application traffic rules dynamically. This allows the redirection of traffic of a certain UE to an enterprise network after the UE has been authenticated and authorized by the MEC application.

### Messages Between the ENSE Application and the MEC Platform

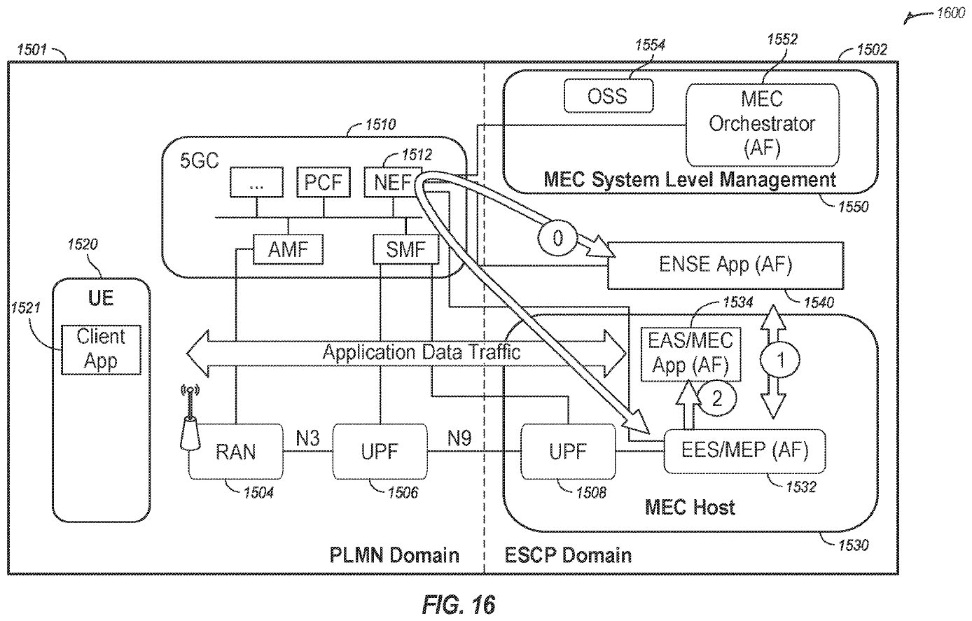

FIG. 16 illustrates a diagram 1600 of example communication between the ENSE application and a MEC platform, according to some examples. Here, diagram 1600 (and the following figures) illustrate a message exchange between the ENSE Application (e.g., ENSE APP 1540) containing the Edge Native Session Management Service (ENSM Service), and the MEC platform (e.g., MEP 1532) corresponding to a MEC host (e.g., MEC host 1530), with the MEC host capable to host a MEC application instance (e.g., MEC APP 1534) tailored to a specific UE (e.g., UE 1520). This MEC application instance (e.g., MEC APP 1534) is tailored to given network and MEC application slicing requirements, in relation to i) new traffic rule addition, ii) existent traffic rule update, and iii) existent traffic rule deletion.

In the diagram 1600, a first message exchange occurs between the ENSE APP 1540 and the EES/MEP 1532, via the NEF 1512 of the 5GC 1510. Then, the EES/MEP 1532 communicates with the ENSE APP 1540. This is followed by communications to the EAS/MEC APP 1534. Additional sequence diagrams are discussed below, to illustrate how the ENSE APP 1540 retrieves information from the MEC platform (e.g., MEP 1532), such as traffic rules corresponding to a specific MEC application instance, including either a whole list of traffic rules or a specific traffic rule. In further examples, the MEC application instance (e.g., MEC APP 1534) is tailored to a specific network and MEC application slice and also to a UE (e.g., UE 1520) with a given ID.

### Configuration and Deployment of an ENSE App

In some examples, the ENSE APP 1540 is deployed and instantiated and seen as an AF by the 5G system. This means that a pre-configuration phase is assumed (e.g., operation numbered “0” in FIG. 16), aiming at establishing authentication and authorization procedures (e.g., via NEF 1512) needed for the ENSE APP 1540 to directly impact the MEC Platform 1532. Afterwards, the subsequent operations (e.g., operations numbered “1” and “2” in FIG. 16) and communications between the ENSE APP 1540 and the MEC Platform 1532 can occur directly, without any intermediation of the NEF 1512. Accordingly, in some examples, it can be assumed that the NEF 1512 is present only in the operation numbered “0” (pre-configuration). In other examples, possible intermediation may occur via the NEF 1512 also including all subsequent operations. In other words, the absence of intermediation with the NEF 1512 in operations “1” and “2” below should not be considered as limiting.

In further examples, the reference point interconnecting the ENSE APP 1540 and the MEC Platform 1532 can be either an evolved version of the Mp1 (defined in the reference MEC architecture in ETSI GS MEC 003), where the corresponding ENSM API can be an API in addition to the existent Mp1-relevant MEC APIs (e.g., MEC application support API and MEC service management API).

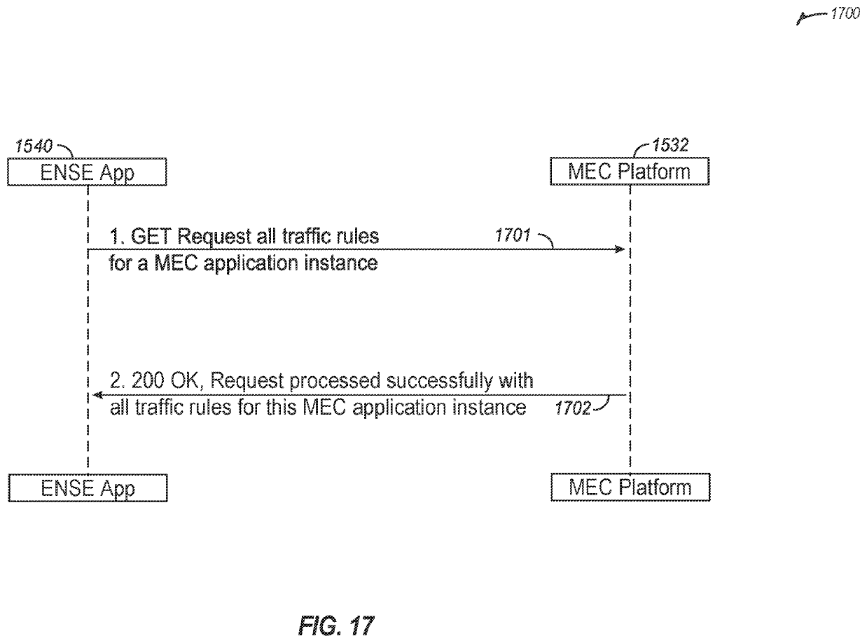

FIG. 17 illustrates example communications 1700 for retrieving information about the list of traffic rules for a MEC application instance, according to some examples. These communications show how the ENSE APP 1540 communicates with the MEC Platform 1532, with the use of a GET request 1701 (to request traffic rules for a MEC application instance) and an OK response 1702 (to obtain information, such as the request is processed successfully with traffic rules for this MEC application instance).

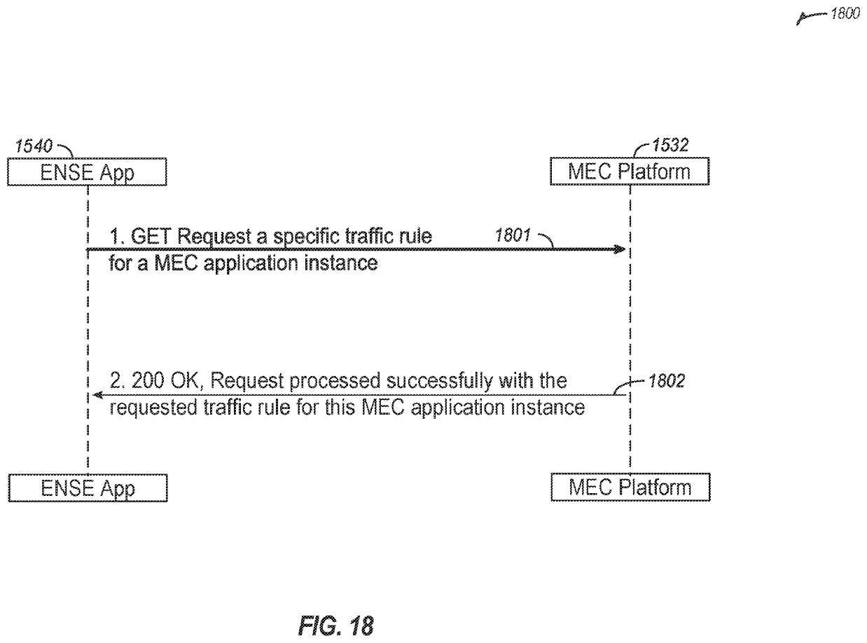

FIG. 18 illustrates example communications 1800 for retrieving information about a specific rule for a MEC application instance, according to some examples. Similar to FIG. 17, these communications 1800 show how the ENSE APP 1540 communicates with the MEC Platform 1532, with the use of a GET request 1801 (to request a specific traffic rule for a MEC application instance) and an OK response 1802 (to obtain information, such as the request is processed successfully with the requested traffic rule for this MEC application instance).

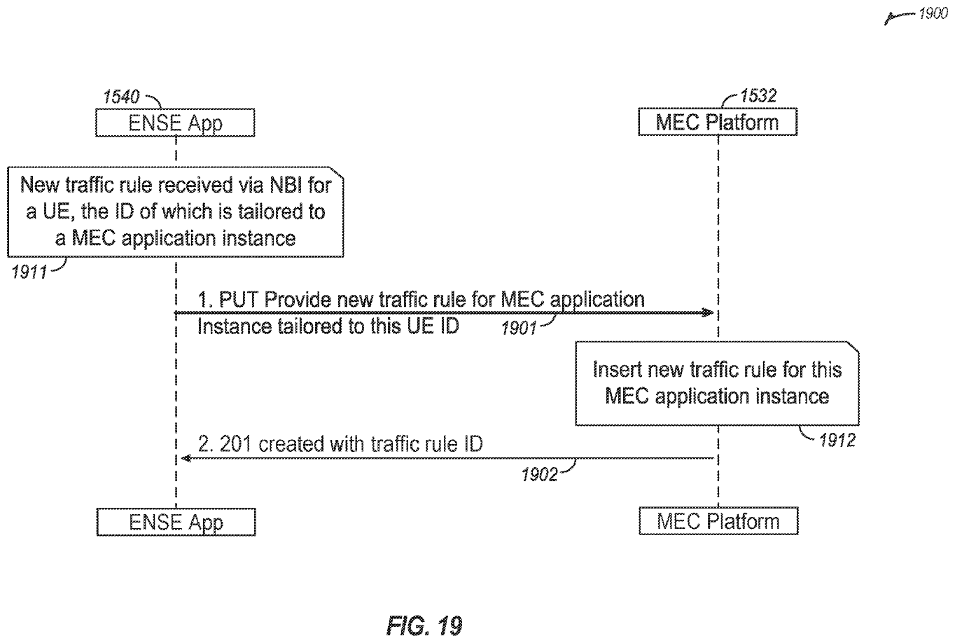

FIG. 19 illustrates example communications 1900 for adding a new traffic rule for a MEC application instance, according to some examples. These communications 1900 are provided in response to the ENSE App 1540 receiving a new traffic rule 1911 (received via NBI for a UE), with the new traffic rule having an ID which is tailored to a MEC application instance. The communications 1900 include use of a PUT request 1901 (to provide the new traffic rule for the MEC application instance tailored to the UE ID), which causes insertion of a new traffic rule 1912 for the MEC application instance at the MEC Platform 1532. This is followed by a 201 “Created” response 1902, which indicates that the request has succeeded and has been created with a traffic rule ID.

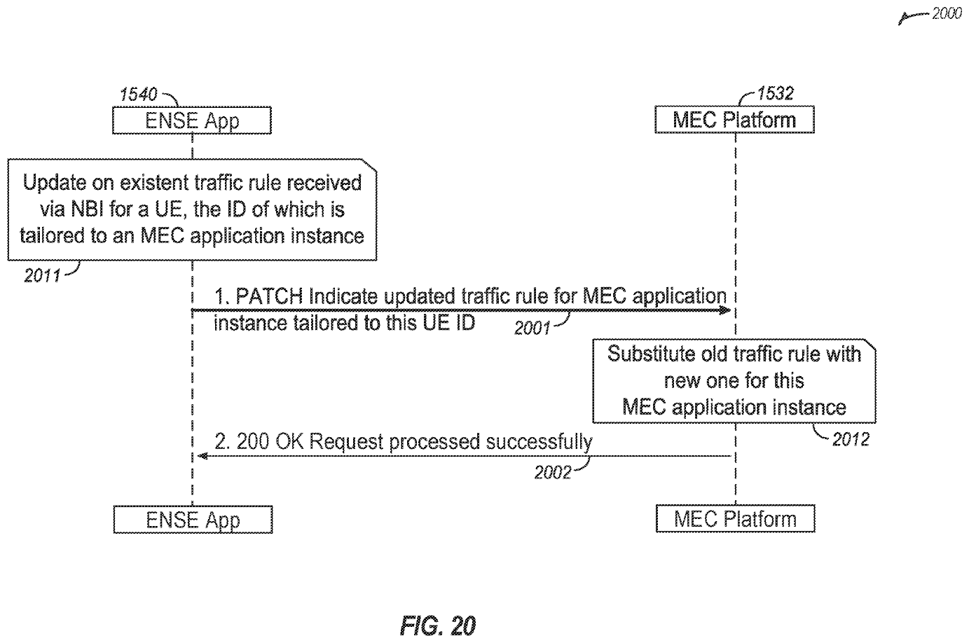

FIG. 20 illustrates example communications 2000 for updating an existing traffic rule for a MEC application instance, according to some examples. These communications 2000 are provided in response to the ENSE App 1540 receiving an updated traffic rule 2011 for an existing traffic rule (received via NBI for a UE), with the existing traffic rule having an ID which is tailored to a MEC application instance. The communications 2000 include use of a PATCH request 2001 (to provide the updated traffic rule for the MEC application instance tailored to the UE ID), which causes substitution of the old traffic rule with a new traffic rule 2012 for the MEC application instance at the MEC Platform 1532. This is followed by a 200 “OK” response 2002 which indicates that the request has succeeded and the update has been processed successfully.

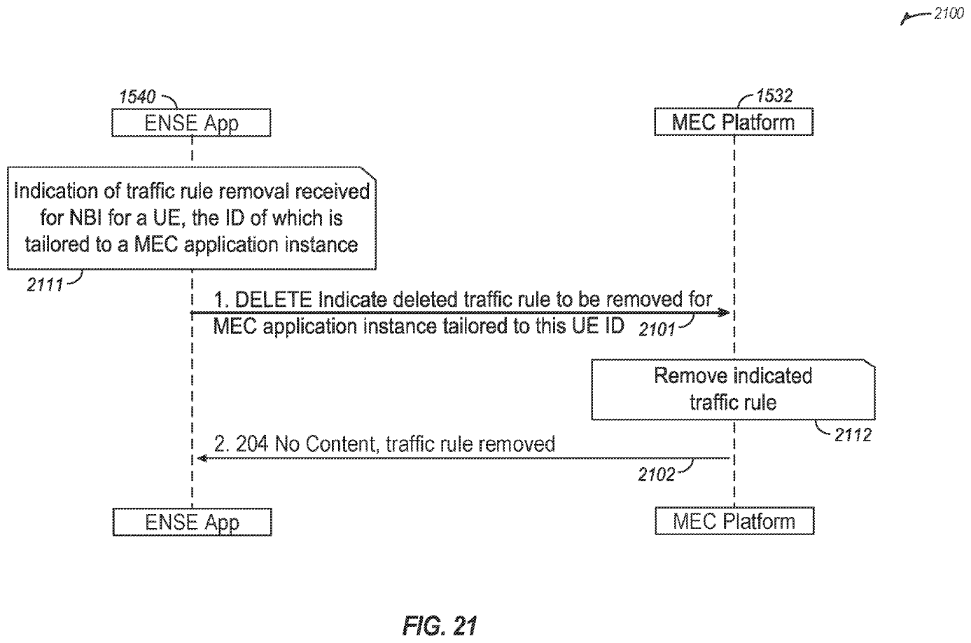

FIG. 21 illustrates example communications 2100 for deleting an existing traffic rule for a MEC application instance, according to some examples. These communications 2100 are provided in response to the ENSE App 1540 receiving an indication of a removed traffic rule 2111 for an existing traffic rule (received via NBI for a UE), with the existing traffic rule having an ID which is tailored to a MEC application instance. The communications 2100 include use of a DELETE request 2101 (to indicate the deleted traffic rule to be removed for the MEC application instance tailored to the UE ID), which causes removal of the indicated traffic rule 2112 for the MEC application instance at the MEC Platform 1532. This is followed by a 204 “No Content” response 2102 which indicates that the request has succeeded and the traffic rule has been removed successfully.

### Signaling Flows for Configuration and Deployment of an ENSE App

The techniques herein also include a procedure used to obtain, achieve, and sustain application QoS per SLA requirements by an ECSP. The consumer at a (third party) ECSP domain represents the customer (vertical segment) side and it is generally termed hereafter as a “Client”. A Client may include a client application (e.g., Client APP 1521) operating on a UE, but may be embodied by other entities. This procedure is introduced in the following examples with a signal flow involving the ENSE app (e.g., ENSE APP 1540), a 3GPP Management System (e.g., in the 5GC 1510), and the ECSP (e.g., via MEC System Management 1550). In the following examples, the Client can provide requests relating to MEC application performance requirements (e.g., maximum tolerable end-to-end latency, jitter, error events, etc.) to the MEO 1552, either as i) CFS portal, therefore involving the Mx1 (NBI) reference point or as an ii) device application, therefore, involving the Mx2 (also NBI) reference point.

In some examples, the requests on updated QoS requirements may be provided more or less frequently in time, depending on the corresponding vertical scenario. For example, end-to-end (E2E) application QoS requirements, and therefore the corresponding traffic rules, may change as the UE repurposes itself and needs to adapt to a new scenario. For example, consider a scenario involving approaching or departing from an intersection when a vehicular UE hosts a client application tailored to a MEC application instance, the traffic rules of which are controlled by the vehicle's OEM through the ENSE APP 1540.

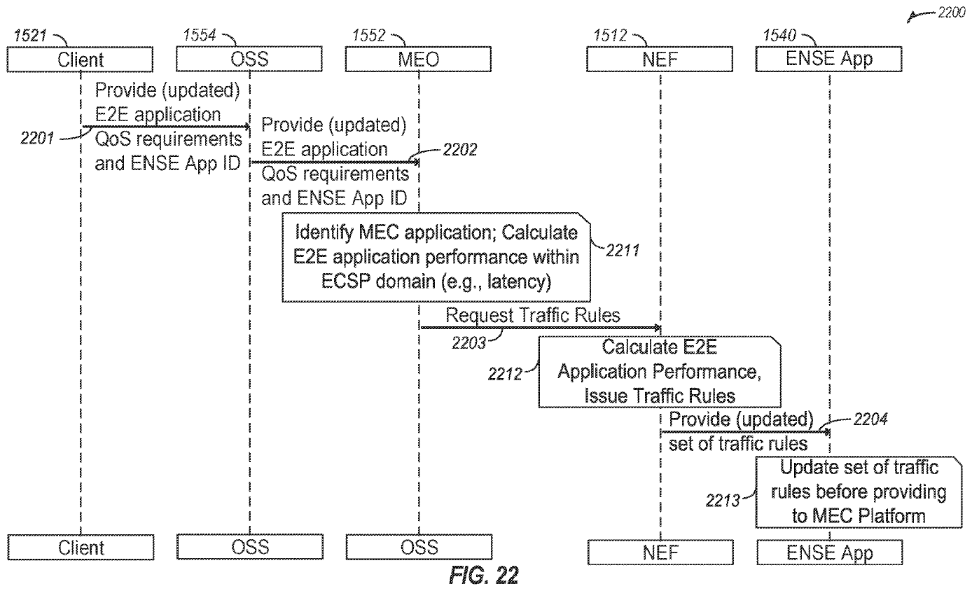

FIG. 22 illustrates an example signaling flow 2200 involving an ENSE APP 1540, a 3GPP management system (NEF 1512), and an edge computing service provider (ECSP) via MEC system management (such as OSS 1554 and MEO 1552), according to some examples. In the sequence diagram of FIG. 22, the following configurations are assumed:
(a) The ENSE APP 1540 is already onboarded by the Client and instantiated in the ECSP Domain 1502 (e.g., at a MEC host 1530);
(b) the MEC system's MEO 1552 is aware of its communication endpoint; and
(c) the Client is aware of the ID of the ENSE APP 1540 instance, e.g., as part of its onboarding procedure.

The signaling flow 2200 includes providing, from the client (e.g., Client APP 1521) to the OSS 1554, end-to-end application QoS requirements and an ENSE application ID, at operation 2201. This information is communicated from the OSS 1554 to the MEO 1552 at operation 2202. Based on this information, the MEO 1552 may identify the MEC application, and calculate end-to-end application performance (e.g., latency and other performance measurements and requirements) within the ECSP domain at operation 2211.

The signaling flow continues at operation 1552 with a request for traffic rules, provided from the MEO 1552 to the NEF 1512 at operation 2203. The NEF 1512 calculates the end-to-end application performance and issues traffic rules at operation 2212. Then, the updated or new set of traffic rules is provided from the NEF 1512 to the ENSE App 1540 at operation 2204. These traffic rules may be updated by the ENSE APP 1540 at operation 2213, before providing to the MEC platform (via the APIs discussed above).

In some examples, the Client can also run in another MEC system since the reference scenario may involve the use of a MEC federation. In such an example, the Client can communicate via MEFs (MEC Federators) and reach out to the target ENSE app (running on the target MEC system). That way, the initial Client request should be forwarded via MEFs to the target MEO. Accordingly, in the case of MEC federation, the sequence diagram in FIG. 22 could be extended in order to have the following end-to-end sequence: Client (at system 1)->MEF1->MEF2->MEO2->NEF2->ENSE App (at target system 2).

The ENSE application can be enabled to influence the traffic flow between a certain UE and the target MEC App (in both directions) to jointly satisfy Network Slice and MEC Application Slice requirements, and accordingly the ENSE application may execute on the same system as the target MEC App. If not running on the same system, other challenges may arise in connection with management and adaptations to manage mobility, user context transfer, slicing management, and the like.

### MEC ENSM Service API

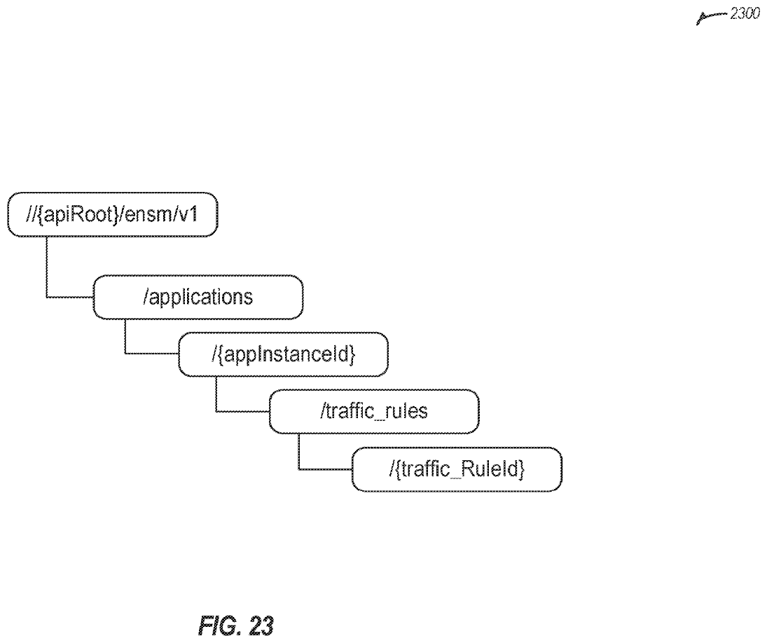

FIG. 23 illustrates an edge-native session management (ENSM) application programming interface (API) tree 2300, according to some examples. This ENSM API tree may be implemented in ETSI MEC scenarios in connection with API specifications, or as service APIs. Table 1 below provides an overview of the resources defined for the ENSM API, and the applicable HTTP methods.

TABLE 1
ENSM Resources and methods overview

| | | HTTP | |
|---|---|---|---|
| Resource name | Resource URI | method | Meaning |
| Parent resource of | /applications/{appInstanceId}/ | GET | Retrieve information about a |
| MEC traffic rules | traffic_rules | | list of MEC traffic rule |
| of a MEC | | | resources for a MEC |
| application | | | application instance tailored |
| instance | | | to a client application with |
| | | | specific application |
| | | | performance requirements |
| Individual MEC | /applications/{appInstanceId}/ | GET | Retrieve information about a |
| traffic rule | traffic_rules/{traffic_RuleId} | | specific MEC traffic rule |
| | | | resource for a MEC |
| | | | application instance |
| | | PUT | Create a new traffic rule for a |
| | | | MEC application instance |
| | | PATCH | Update information about an |
| | | | existent traffic rule for a |
| | | | MEC application instance |
| | | DELETE | Delete a MEC traffic rule |
| | | | resource for a MEC |
| | | | application instance |

The ENSE application, edge-native management system, 3GPP system, and MEC system and related techniques discussed herein are relevant to a variety of standards and implementation efforts. For example, MEC 044 is an ongoing standards effort establishing specifications of MEC Application Slices. The items referred to as a “MEC App slice” in MEC 044 can correspond to the examples of an ENSE App discussed above. Further, recommendations 5.6.2-1 and 5.6.2-2 in MEC 044 involve a selection of a MEC host and communication network to satisfy the QoS needs based on service level. These recommendations are addressed by the techniques discussed herein, that enable the ENSE application to influence the traffic flow between a certain UE and the target MEC App (in both directions) and jointly satisfy Network Slice and MEC Application Slice requirements.

As another example, the 5GFF “5G Future Forum” is defining an API for edge selection (as an industry solution) with an “Edge Discovery Service”, also known an “EDS API”, with a goal to select the optimal edge host for a certain user. This selection can be provided by use of the presently discussed ENSE App capabilities that setup traffic for a certain link between UE and target application.

As another example, the CAMARA open source implementation project has provided development of a “Traffic Influence API”. Use of this API to select and manage specific connections may be enabled by the use of the presently discussed ENSE App. For example, consider a proposed use of the Traffic Influence API to provide the AF with the ability to modify the connection policies of UEs and EAS in terms of how the traffic flows (e.g., QoS and routing). With use of the present techniques, a UPF in a 5G network—connected to the target Data Network—can be updated with new traffic steering rules, for a set of users, with a specific QoS, for a specific time period. Furthermore, in a UE mobility scenario, the PDU Session Anchor UPF, may be relocated considering the latency requirements provided by the AF.

Other scenarios in CARMERA may include the AF requesting the connection of an EAS to the Core Network user plane, typically at the Edge. Local Breakout (LBO) that break out internet sessions into a home network on 4G or 5G networks, with the closest UPF, may also be implemented with the present techniques. A further scenario may include the UE moving from one geographical area to another. The AF could move the application session from one EAS in one Edge Data Network to another EAS in another Edge Data Network. As a consequence, a new anchor UPF could be selected.

Other standardization and implementation efforts attempted in 3GPP may be enhanced or improved by the present techniques. This includes management of the edge network and application information (e.g., EAS load, UPF and EAS deployment information, Data Network Access Identifiers (DNAIs)) locally and more efficiently with less impact to 5GC central NFs (e.g., a central SMF). This also has the technical benefit of providing more flexible EAS (re) discovery, (re) selection, and local UPF (re) selection.

### IMPLEMENTATION EXAMPLES

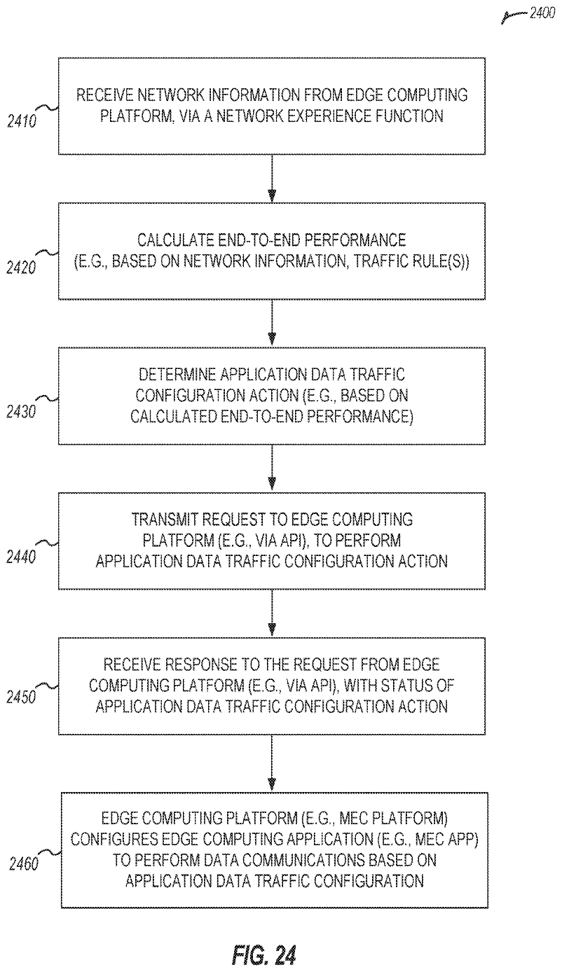

FIG. 24 illustrates a flowchart 2400 of an example method for managing a MEC application with use of Edge-Native Session Management functions. In an example, the following operations are performed by a session management function application, such as at the ENSE APP 1540 discussed above. However, other functions and applications of an edge computing or networking system may perform some or all of the following operations.

Operation 2410 includes receiving network information from an edge computing platform that includes an edge computing application. This network information may be received via a network experience function of a mobile network. In one example, the edge computing platform and the edge computing application are configured in accordance with a standard from an European Telecommunications Standards Institute (ETSI) Multi-Access Edge Computing (MEC) standards family, such that the edge computing platform is a MEC platform, and the edge computing application is a MEC application. In another example, the edge computing platform and the edge computing application are configured in accordance with a standard from an 3rd Generation Partnership Project (3GPP) EDGEAPP standards family, such that the edge computing platform is a EDGEAPP Edge Enabler Server (EES), and the edge computing application is an Edge Application Server (EAS) application.

Operation 2420 includes calculating end-to-end performance applicable to the client and application. This calculation may be based on the received network information, and at least one traffic rule applicable to the mobile network, the edge computing platform, or related entities. Operation 2430 includes determining an application data traffic configuration action, such as based on this calculated end-to-end performance.

Operation 2440 includes transmitting a request to edge computing platform (e.g., via the APIs of the edge computing platform discussed above), to perform an application data traffic configuration action. This request may be based on the received network information, and the calculated end-to-end performance and various E2E requirements or network objectives. In an example, the request includes an application data traffic configuration action to perform on the edge computing application (e.g., via the API actions discussed above).

Operation 2450 includes to receive a response to the request from edge computing Platform (e.g., via the APIs of the edge computing platform discussed above), with a status of the application data traffic configuration action. This application data traffic configuration action may include establishing or updating a traffic rule for communications at or with the edge computing application, as discussed above. In a specific example, the application data traffic configuration action is determined by an orchestrator (e.g., MEC orchestrator) associated with the edge computing platform, and the application data traffic configuration action is based on an application requirement or Quality of Service (QoS) requirement provided by the mobile network to the orchestrator. For instance, the application requirement or the QoS requirement may correspond to use of a client application of a user equipment (UE) of the mobile network, with the use of the client application providing application data traffic to the edge computing application.

Operation 2460 includes the edge computing platform (e.g., MEC Platform or EES) configuring the edge computing application (e.g., a MEC App or an EAS App) to perform data communications based on the application data traffic configuration. In an example, subsequent communications that conduct application data traffic with a client, performed at or with the edge computing application, are modified based on the application data traffic configuration action.

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

Example 1 is a method for configuration of an edge computing application, performed by a session management function application, the method comprising: receiving network information from an edge computing platform, the edge computing platform including an edge computing application, wherein the network information is received via a network experience function of a mobile network; transmitting a request to the edge computing platform, based on the received network information, the request including an application data traffic configuration action to perform on the edge computing application; and receiving a response to the request from the edge computing platform, the response indicating a status of the application data traffic configuration action performed on the edge computing application.

In Example 2, the subject matter of Example 1 optionally includes subject matter where subsequent communications that conduct application data traffic with a client, performed at the edge computing application, are modified based on the application data traffic configuration action.

In Example 3, the subject matter of any one or more of Examples 1-2 optionally include subject matter where transmitting the request or receiving the response to the request (or, both transmitting and receiving) is performed using an application programming interface (API) of the edge computing platform.

In Example 4, the subject matter of any one or more of Examples 1-3 optionally include subject matter where the application data traffic configuration action includes to establish or update a traffic rule for communications at the edge computing application.

In Example 5, the subject matter of Example 4 optionally includes subject matter where the application data traffic configuration action is determined by an orchestrator associated with the edge computing platform, and wherein the application data traffic configuration action is based on an application requirement or Quality of Service (QoS) requirement provided by the mobile network to the orchestrator.

In Example 6, the subject matter of Example 5 optionally includes subject matter where the application requirement or the QoS requirement corresponds to use of a client application of a user equipment (UE) of the mobile network, the use of the client application to provide application data traffic to the edge computing application.

In Example 7, the subject matter of any one or more of Examples 1-6 optionally include calculating end-to-end application performance, at the session management function application, based on the received network information and at least one traffic rule; and determining the application data traffic configuration action, at the session management function application, based on the calculated end-to-end application performance.

In Example 8, the subject matter of any one or more of Examples 1-7 optionally include subject matter where the edge computing platform and the edge computing application are configured in accordance with a standard from an European Telecommunications Standards Institute (ETSI) Multi-Access Edge Computing (MEC) standards family, wherein the edge computing platform is a MEC platform, and wherein the edge computing application is a MEC application.

In Example 9, the subject matter of any one or more of Examples 1-8 optionally include subject matter where the edge computing platform and the edge computing application are configured in accordance with a standard from an 3rd Generation Partnership Project (3GPP) EDGEAPP standards family, wherein the edge computing platform is a EDGEAPP Edge Enabler Server (EES), and wherein the edge computing application is an Edge Application Server (EAS) application.

In Example 10, the subject matter of any one or more of Examples 1-9 optionally include subject matter where the mobile network is a 3rd Generation Partnership Project (3GPP) fifth generation (5G) network, and wherein the network experience function is a NEF function of the 5G network.

Example 11 is a computing device, comprising: communications circuitry configured to perform communications with a network experience function of a mobile network; and processing circuitry configured to: receive network information from an edge computing platform, via the network experience function of the mobile network, the edge computing platform including an edge computing application; transmit a request to the edge computing platform via the communications circuitry, based on the received network information, the request including an application data traffic configuration action to perform on the edge computing application; and receive a response to the request from the edge computing platform via the communications circuitry, the response indicating a status of the application data traffic configuration action performed on the edge computing application.

In Example 12, the subject matter of Example 11 optionally includes subject matter where subsequent communications that conduct application data traffic with a client, performed at the edge computing application, are modified based on the application data traffic configuration action.

In Example 13, the subject matter of any one or more of Examples 11-12 optionally include subject matter where transmitting the request or receiving the response to the request (or, both transmitting and receiving) is performed using an application programming interface (API) of the edge computing platform.

In Example 14, the subject matter of any one or more of Examples 11-13 optionally include subject matter where the application data traffic configuration action includes to establish or update a traffic rule for communications at the edge computing application.

In Example 15, the subject matter of Example 14 optionally includes subject matter where the application data traffic configuration action is determined by an orchestrator associated with the edge computing platform, and wherein the application data traffic configuration action is based on an application requirement or Quality of Service (QoS) requirement provided by the mobile network to the orchestrator.

In Example 16, the subject matter of Example 15 optionally includes subject matter where the application requirement or the QoS requirement corresponds to use of a client application of a user equipment (UE) of the mobile network, the use of the client application to provide application data traffic to the edge computing application.

In Example 17, the subject matter of any one or more of Examples 11-16 optionally include subject matter where the processing circuitry is further configured to: calculate end-to-end application performance, based on the received network information and at least one traffic rule; and determine the application data traffic configuration action, based on the calculated end-to-end application performance.

In Example 18, the subject matter of any one or more of Examples 11-17 optionally include subject matter where the edge computing platform and the edge computing application are configured in accordance with a standard from an European Telecommunications Standards Institute (ETSI) Multi-Access Edge Computing (MEC) standards family, wherein the edge computing platform is a MEC platform, and wherein the edge computing application is a MEC application.

In Example 19, the subject matter of any one or more of Examples 11-18 optionally include subject matter where the edge computing platform and the edge computing application are configured in accordance with a standard from an 3rd Generation Partnership Project (3GPP) EDGEAPP standards family, wherein the edge computing platform is a EDGEAPP Edge Enabler Server (EES), and wherein the edge computing application is an Edge Application Server (EAS) application.

In Example 20, the subject matter of any one or more of Examples 11-19 optionally include subject matter where the mobile network is a 3rd Generation Partnership Project (3GPP) fifth generation (5G) network, and wherein the network experience function is a NEF function of the 5G network.

Example 21 is at least one machine-readable storage medium (e.g., non-transitory machine-readable storage medium) comprising instructions stored thereupon, which when executed by circuitry of a computing machine, cause the circuitry to: receive network information from an edge computing platform, the edge computing platform including an edge computing application, wherein the network information is received via a network experience function of a mobile network; transmit a request to the edge computing platform, based on the received network information, the request including an application data traffic configuration action to perform on the edge computing application; and receive a response to the request from the edge computing platform, the response indicating a status of the application data traffic configuration action performed on the edge computing application.

In Example 22, the subject matter of Example 21 optionally includes subject matter where subsequent communications that conduct application data traffic with a client, performed at the edge computing application, are modified based on the application data traffic configuration action.

In Example 23, the subject matter of any one or more of Examples 21-22 optionally include subject matter where operations to transmit the request and to receive the response to the request is performed using an application programming interface (API) of the edge computing platform.

In Example 24, the subject matter of any one or more of Examples 21-23 optionally include subject matter where the application data traffic configuration action includes to establish or update a traffic rule for communications at the edge computing application.

In Example 25, the subject matter of Example 24 optionally includes subject matter where the application data traffic configuration action is determined by an orchestrator associated with the edge computing platform, and wherein the application data traffic configuration action is based on an application requirement or Quality of Service (QoS) requirement provided by the mobile network to the orchestrator.

In Example 26, the subject matter of Example 25 optionally includes subject matter where the application requirement or the QoS requirement corresponds to use of a client application of a user equipment (UE) of the mobile network, the use of the client application to provide application data traffic to the edge computing application.

In Example 27, the subject matter of any one or more of Examples 21-26 optionally include subject matter where the instructions further cause the circuitry to: calculate end-to-end application performance, based on the received network information and at least one traffic rule; and determine the application data traffic configuration action, based on the calculated end-to-end application performance.

In Example 28, the subject matter of any one or more of Examples 21-27 optionally include subject matter where the edge computing platform and the edge computing application are configured in accordance with a standard from an European Telecommunications Standards Institute (ETSI) Multi-Access Edge Computing (MEC) standards family, wherein the edge computing platform is a MEC platform, and wherein the edge computing application is a MEC application.

In Example 29, the subject matter of any one or more of Examples 21-28 optionally include subject matter where the edge computing platform and the edge computing application are configured in accordance with a standard from an 3rd Generation Partnership Project (3GPP) EDGEAPP standards family, wherein the edge computing platform is a EDGEAPP Edge Enabler Server (EES), and wherein the edge computing application is an Edge Application Server (EAS) application.

In Example 30, the subject matter of any one or more of Examples 21-29 optionally include subject matter where the mobile network is a 3rd Generation Partnership Project (3GPP) fifth generation (5G) network, and wherein the network experience function is a NEF function of the 5G network.

Example 31 is a device, comprising processing circuitry configured to implement MEC-enabled edge-native management system of edge applications in accordance with the techniques discussed herein.

Example 32 is a method, comprising a plurality of operations executed with a processor and memory of a device, to perform operations in a data processing system, including for implementing MEC-enabled edge-native management system of edge applications in accordance with the techniques discussed herein.

Example 33 is a non-transitory device-readable storage medium comprising information representative of instructions, wherein the instructions, when executed by the processing circuitry of a device, cause the processing circuitry for MEC-enabled edge-native management system of edge applications in accordance with the techniques discussed herein.

Example 34 is an apparatus, comprising a plurality of means for operating a telemetry utilization data processing system, including for implementing MEC-enabled edge-native management system of edge applications in accordance with the techniques discussed herein.

Example 35 is a device fog adapted to perform the operations or techniques discussed herein.

Example 36 is an edge computing device adapted to perform the operations or techniques discussed herein.

Example 37 is a cloud service server adapted to perform the operations of a cloud service invoked by the operations or techniques discussed herein.

Example 38 is a multi-access edge computing (MEC) device, configured as a server, gateway, orchestrator, platform manager, client, or intermediary according to a MEC specification, comprising means to implement the operations or techniques discussed herein.

Example 39 is a network comprising respective devices and device communication mediums for performing any of the operations or techniques discussed herein.

Example 40 is a system comprising respective components arranged or configured to perform any of the operations or techniques discussed herein.

It should be understood that the functional units or capabilities described in this specification may have been referred to or labeled as components, circuits, or modules, to indicate their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field-programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together but may comprise disparate instructions stored in different locations which, when joined logically together, comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center) than that in which the code is deployed (e.g., in a computer embedded in a sensor or robot). Similarly, operational data may be identified and illustrated herein within components or modules and may be embodied in any suitable form and organized within any suitable type of data structure. The operational data may be collected as a single data set or may be distributed over different locations including over different storage devices, and may exist, at least partially, merely as electronic signals on a system or network. The components or modules may be passive or active, including agents operable to perform desired functions.

Although these implementations have been described with reference to specific exemplary aspects, it will be evident that various modifications and changes may be made to these aspects without departing from the broader scope of the present disclosure. Many of the arrangements and processes described herein can be used in combination or parallel implementations to provide greater bandwidth/throughput and to support edge services selections that can be made available to the edge systems being serviced. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

Such aspects of the inventive subject matter may be referred to herein, individually and/or collectively, merely for convenience and without intending to voluntarily limit the scope of this application to any single aspect or inventive concept if more than one is disclosed. Thus, although specific aspects have been illustrated and described herein, it should be appreciated that any arrangement calculated to achieve the same purpose may be substituted for the specific aspects shown. This disclosure is intended to cover any adaptations or variations of various aspects. Combinations of the above aspects and other aspects not specifically described herein will be apparent to those of skill in the art upon reviewing the above description.

1. A computing device, comprising:
communications circuitry configured to perform communications with a network experience function of a mobile network; and
processing circuitry configured to:
receive network information from an edge computing platform, via the network experience function of the mobile network, the edge computing platform including an edge computing application;
transmit a request to the edge computing platform via the communications circuitry, based on the received network information, the request including an application data traffic configuration action to perform on the edge computing application; and
receive a response to the request from the edge computing platform via the communications circuitry, the response indicating a status of the application data traffic configuration action performed on the edge computing application.

2. The computing device of claim 1, wherein subsequent communications that conduct application data traffic with a client, performed at the edge computing application, are modified based on the application data traffic configuration action.

3. The computing device of claim 1, wherein transmitting the request is performed using an application programming interface (API) of the edge computing platform.

4. The computing device of claim 1, wherein the application data traffic configuration action includes to establish or update a traffic rule for communications at the edge computing application.

5. The computing device of claim 4, wherein the application data traffic configuration action is determined by an orchestrator associated with the edge computing platform, and wherein the application data traffic configuration action is based on an application requirement or Quality of Service (QoS) requirement provided by the mobile network to the orchestrator.

6. The computing device of claim 5, wherein the application requirement or the QoS requirement corresponds to use of a client application of a user equipment (UE) of the mobile network, the use of the client application to provide application data traffic to the edge computing application.

7. The computing device of claim 1, wherein the processing circuitry is further configured to:
calculate end-to-end application performance, based on the received network information and at least one traffic rule; and
determine the application data traffic configuration action, based on the calculated end-to-end application performance.

8. The computing device of claim 1, wherein the edge computing platform and the edge computing application are configured in accordance with a standard from an European Telecommunications Standards Institute (ETSI) Multi-Access Edge Computing (MEC) standards family, wherein the edge computing platform is a MEC platform, and wherein the edge computing application is a MEC application.

9. The computing device of claim 1, wherein the edge computing platform and the edge computing application are configured in accordance with a standard from an 3rd Generation Partnership Project (3GPP) EDGEAPP standards family, wherein the edge computing platform is a EDGEAPP Edge Enabler Server (EES), and wherein the edge computing application is an Edge Application Server (EAS) application.

10. The computing device of claim 1, wherein the mobile network is a 3rd Generation Partnership Project (3GPP) fifth generation (5G) network, and wherein the network experience function is a NEF function of the 5G network.

11. A method for configuration of an edge computing application, performed by a session management function application, the method comprising:
receiving network information from an edge computing platform, the edge computing platform including an edge computing application, wherein the network information is received via a network experience function of a mobile network;
transmitting a request to the edge computing platform, based on the received network information, the request including an application data traffic configuration action to perform on the edge computing application; and
receiving a response to the request from the edge computing platform, the response indicating a status of the application data traffic configuration action performed on the edge computing application.

12. The method of claim 11, wherein subsequent communications that conduct application data traffic with a client, performed at the edge computing application, are modified based on the application data traffic configuration action.

13. The method of claim 11, wherein transmitting the request is performed using an application programming interface (API) of the edge computing platform.

14. The method of claim 11, wherein the application data traffic configuration action includes to establish or update a traffic rule for communications at the edge computing application.

15. The method of claim 14, wherein the application data traffic configuration action is determined by an orchestrator associated with the edge computing platform, and wherein the application data traffic configuration action is based on an application requirement or Quality of Service (QoS) requirement provided by the mobile network to the orchestrator.

16. The method of claim 15, wherein the application requirement or the QoS requirement corresponds to use of a client application of a user equipment (UE) of the mobile network, the use of the client application to provide application data traffic to the edge computing application.

17. The method of claim 11, further comprising:
calculating end-to-end application performance, at the session management function application, based on the received network information and at least one traffic rule; and
determining the application data traffic configuration action, at the session management function application, based on the calculated end-to-end application performance.

18. The method of claim 11, wherein the edge computing platform and the edge computing application are configured in accordance with a standard from an European Telecommunications Standards Institute (ETSI) Multi-Access Edge Computing (MEC) standards family, wherein the edge computing platform is a MEC platform, and wherein the edge computing application is a MEC application.

19. The method of claim 11, wherein the edge computing platform and the edge computing application are configured in accordance with a standard from an 3rd Generation Partnership Project (3GPP) EDGEAPP standards family, wherein the edge computing platform is a EDGEAPP Edge Enabler Server (EES), and wherein the edge computing application is an Edge Application Server (EAS) application.

20. The method of claim 11, wherein the mobile network is a 3rd Generation Partnership Project (3GPP) fifth generation (5G) network, and wherein the network experience function is a NEF function of the 5G network.

21. (canceled)
